(19) United States
(12) Patent Application Publication
(10) Pub. No.: US 2011/0264460 A1
(43) Pub. Date: Oct. 27, 2011

(54) SYSTEM AND METHOD FOR PROVIDING A SECURE REGISTRY FOR HEALTHCARE RELATED PRODUCTS AND SERVICES

(75) Inventors: Paula L. Jagemann, Frederick, MD (US); Andrew Z. Schiff, Silver Spring, MD (US)

(73) Assignee: Someone With, LLC, Frederick, MD (US)

(21) Appl. No.: 13/092,668

(22) Filed: Apr. 22, 2011

Related U.S. Application Data
(60) Provisional application No. 61/327,555, filed on Apr. 23, 2010.
(60) Provisional application No. 61/394,550, filed on Oct. 19, 2010.
(60) Provisional application No. 61/447,381, filed on Feb. 28, 2011.

(51) Int. Cl. G06Q 50/00

(52) U.S. Cl. 705/2

(57) ABSTRACT

A computer-implemented method, apparatus, and system for servicing the needs of customers with a particular disease or disorder. A catalog of specialty items relevant to the needs of individual customers at a given stage of the disease or disorder or treatment cycle may be provided. Secure personal registries of items selected from the catalog by a customer may be provided. Experts and other third parties may recommend items for inclusion in the personal registry of the customer. Experts, customers, and/or third-parties may recommend additional items for inclusion into the catalog of specialty items. The catalog may also be updated based on sales information. Third parties may make a financial contribution or an in-kind contribution to the customer's registry. The relationship between the catalog of specialty items, recommenders, and customers, may be managed by the system while the privacy of personal customer data may be maintained.

### CROSS REFERENCE TO RELATED APPLICATIONS

This patent application claims the benefit of U.S. Provisional Application No. 61/327,555, filed Apr. 23, 2010, U.S. Provisional Application No. 61/394,550, filed Oct. 19, 2010, and U.S. Provisional Application No. 61/447,381, filed Feb. 28, 2011. Provisional Application Nos. 61/327,555, 61/394,550, and 61/447,381 are hereby incorporated by reference in their entirety.

### BACKGROUND

1. Field of Invention

Embodiments of the present invention relate generally to ecommerce, and more particularly to a communication system and method designed to disseminate customer requirements with various provider types.

2. Background

The current healthcare system has been governed the same way for many years. Minor modifications have been made to push more costs to the individual. Despite the revolution of social media, the ability to quickly communicate with third parties about needs, and the current inability to monitor financial contributions made in the spirit of aiding a “medical crisis” are all outdated. The failure points are many. Fraud is rampant.

### SUMMARY

Aspects of the invention may involve systems, methods, and computer readable medium. In one embodiment of the invention, computer-readable storage media may be provided that may contain the following instructions. Providing a catalog, where the catalog may contain specialty items relevant to a particular disease or disorder at a given stage or treatment cycle of the disease or disorder. Providing a secure personal registry of one or more specialty items selected from the catalog by a customer. Receiving registry item recommendations for inclusion into the secure personal registry, where the registry item recommendations may be provided by experts, customers, and/or third-parties. Receiving catalog item recommendations from experts, customers, and/or third-parties. Updating the catalog based on the catalog item recommendations and/or on specialty items sales data. Receiving a financial contribution and/or an in-kind contribution to the secure personal registry of specialty items from a contributor. Processing a sales transaction for one or more specialty items in the secure personal registry. Storing relational data regarding the specialty items, customers, registry item recommendations, catalog item recommendations, sales transaction, and/or the disease or disorder.

In another embodiment, a computer-implemented method for servicing the needs of customers with diseases or disorders may be described. The method may involve associating each customer with a particular disease or disorder at a particular stage or treatment cycle. Providing a comprehensive catalog including specialty items targeted to customers based on the customer's particular disease or disorder at the particular stage or treatment cycle. Providing secure registries associated with customers. Receiving registry recommendations of specialty items from experts and/or customers. Providing registry recommendations to customers based on the particular disease or disorder at the particular stage or treatment cycle of the disease or disorder. Receiving a customer selection of a specialty item from the registry recommendations. Inserting the specialty item into an individual secure registry. Transmitting to the contributor a link allowing viewing of the individual secure registry. Accepting a monetary contribution into the individual secure registry. Transmitting notification of the monetary contribution.

In another embodiment, a computer-implemented system for servicing needs of customers with a particular disease or disorder may be described. This embodiment may include a storage device storing a relational database holding relational information on specialty items, item ingredients, customer data, diseases, disorders, stages of the disease and/or disorder, treatment cycles, expert recommendations, and/or customer reviews. The system may also contain a processor configured. The processor may be configured to do the following. Process a catalog of specialty items relevant to the needs of individual customers at a given stage or treatment cycle of the disease or disorder. Process secure personal registries of specialty items selected from the catalog by individual customers. Process recommendations from experts on specialty items for inclusion in personal registries of individual customers. Process recommendations from experts and/or customers on specialty items for inclusion and/or exclusion from the catalog. Update the specialty items in the catalog based on the recommendations from experts and/or customers. Process contributions from contributors of funds to personal registries, where the contributions may be whole or partial purchase price of an item. Collecting relational information and maintaining privacy of personal customer data stored on the storage device.

In another embodiment, a computer-implemented method for matching patients with contributors may be described. The method may involve providing a catalog of products for customers, where the customers may be patients and/or survivors and the products may be goods and/or services. Providing a registry for each customer, where the registry may contain a selection of one or more products from the catalog of products. Receiving product recommendations from a medical doctor. Transmitting to the medical doctor an ingredient list for the products recommendations. Providing a list of recommended products based on a selection of the medical doctor. Inserting one or more doctor recommended products into the registry. Transmitting a link to a contributor, where the link may allow the contributor to access the registry. Receiving a contribution from the contributor for a purchase of one or more products in the registry and/or a monetary contribution. Receiving one or more customer ratings for one or more products.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 depicts an illustrative high-level flow diagram for use with an example method of providing a secure registry;

FIG. 2 depicts an illustrative home webpage illustrating an example method of providing a secure registry;

FIG. 3 depicts an illustrative product page illustrating an example method of providing a secure registry;

FIG. 4 depicts an illustrative registry page illustrating an example method of providing a secure registry;

FIG. 5 depicts an illustrative customer workflow for use with an example method of providing a secure registry;

FIG. 6 depicts an illustrative webpage email template for use with an example method of providing a secure registry;

FIG. 7 depicts an illustrative received email for use with an example method of providing a secure registry;

FIG. 8 depicts an illustrative registry page for a contributor for use with an example method of providing a secure registry;

FIG. 9 depicts an illustrative monetary contribution page for use with an example method of providing a secure registry;

FIG. 10 depicts an illustrative shopping cart for use with an example method of providing a secure registry;

FIG. 11 depicts an illustrative checkout options page for use with an example method of providing a secure registry;

FIG. 12 depicts an illustrative quicklist creation workflow for use with an example method of providing a secure registry;

FIG. 13 depicts an illustrative contributor workflow for use with an example method of providing a secure registry;

FIG. 14 depicts an illustrative computer system for use with an example method of providing a secure registry;

FIG. 15 depicts an illustrative network for use with an example method of providing a secure registry; and

FIG. 16 depicts an illustrative high-level system flow diagram for use with an example method of providing a secure registry.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples. The term “product” may refer to both products and services.

### Introduction

One embodiment of this invention can help individuals with diseases and/or disorders (e.g., breast cancer, prostate cancer, lupus, arthritis, heart disease, autism, multiple sclerosis, sleep disorders, migraines, etc.) by combining and providing ecommerce and social media tools, for example, to ease the personal and financial burden of disease management. The current state of the art does not provide for a system or method to conveniently purchase quality home health and medical supplies while observing the Health Insurance Portability and Accountability Act of 1996 (HIPAA). The current state of the art does not provide a robust resource for home health and/or medical supplies which leaves a significant number of first time buyers spending an great deal of time searching for unfamiliar—often-expensive—products with little guidance and overwhelming financial burden.

One embodiment of the invention may include an online and print specialty product catalog specifically created to support the consumer experience by streamlining processes related to product identification, sourcing, and shipping, directly related to or in coordination with an individual's medical course of treatment in chronic or catastrophic disease management. This includes pre-, during- and post-treatment product selection support as well as product satisfaction ratings and crowd-sourced product identification/selection/retention. In addition, an embodiment may offer novel financial solutions to combat the financial burden that accompanies catastrophic or chronic disease management, such as cancer, diabetes, Parkinson's, Multiple Sclerosis, Autism, etc. One in ten people will encounter a “chronic” disease in their lifetime. An embodiment may provide specialty products that are otherwise difficult to find, while integrating systems to help ease the financial burden associated with catastrophic or chronic disease management. One in ten people battling cancer, go bankrupt.

An embodiment of this invention may include a method for product identification, sourcing, and shipping in a compassionate and dignified manner while providing for unique financial support. A customer may spend hours, looking for unfamiliar and expensive categories of products, such as “drainage belts,” compression gauntlets, chemotherapy ready skin care products, etc. By applying expert advice and research, an embodiment of this invention may provide for typically incomparable product identification, often from small, niche and unsophisticated manufacturers. Few of the manufacturers of products for disease maintenance and wellbeing use professional distribution networks or wholesalers, as the products may straddle health and beauty and medicinal. For products that are not categorized as a medical necessity and are not “reimbursable,” the product availability tends to be limited and one can expect to spend hours researching and procuring the products and services. For patients or caregivers this time may be precious and should be spent managing their disease or spending time with loved ones.

Once products are identified an embodiment of this invention may source them from one location, so customers can receive one beautifully, carefully packaged box and one receipt for streamlined medical/tax/personal record keeping for products which may have been screened by experts in their fields, and rated by others undergoing the same medical journey or procedures. An embodiment of the invention may be committed to being the most relevant catalog to patients' during a medical crisis. Products that do not maintain a certain level of satisfaction may be pulled from the catalog, e-retail store, and inventory. Every activity will be self-governed by our customers and experts in that category of care, which may provide customers with unique feedback directly from other people who have had personal experience with the products and services.

Outside of product identification and sourcing, which could impact a medical crisis or other time-sensitive product and service needs, an embodiment of this invention may provide a novel mechanism to allow others to aid in a patient's expense stream, while currently mandated honoring medical privacy (e.g., HIPAA) protections. A “registry” may be created that, unlike existing bridal or baby registries, which are open to anyone, may be closed unless patients which/that wish to privately and securely invite individuals to view and contribute to their registry.

An embodiment of this invention offers products that may be closely tied to disease and/or disorder management, such as breast or prostate cancers. Therefore, an open “registry” could lead to the unwanted disclosure of medical conditions. An embodiment of this invention may offer a way for any third parties to contribute to a patient's financial burden. In this instance, third parties are not just limited to friends and family, but may include any third party including public or private foundations and groups or entities that have missions that align with an individual's current time sensitive needs.

Contributions may come in the form of outright financial support as a dollar amount (for use towards, for example, products, services, co-pays, etc.), the procurement of a specific product or service, discounts, coupons, or offerings of free services or products. This may provide an opportunity for people to provide financial support during a person's greatest time of need. Previously, people who wanted to support patients were relegated to buying flowers, balloons, books, or otherwise, sympathetic, but, unproductive gifts. The opportunity to pool financial resources and apply them to health and medical expenses may have a meaningful impact on patients' expenses.

Not only are physical products (that can be touched, boxed or shipped) offered but services may also be offered. Services may include co-pays and treatment options that may not be covered by reimbursement, such as complementary or alternative therapies sought outside of the course of traditional treatment (e.g., Reiki, acupuncture, nutrition counseling, exercise, meditation, medically oriented or spiritual healing journeys, etc). Products that contributors want to contribute to help a patient manage during his/her time of need may include “fully restricted giving” down to the Merchant and, ultimately SKU/SIC code level to open contributions.

Currently, HIPAA may restrict the receipt of payment from anyone outside of a patient's healthcare coverage plan (e.g., spouse, parents or children). Sorority sisters, co-workers, church groups, friends and extended family, for example, are relegated to giving funds directly to the individual in need. Once those funds are transferred it is up to “good faith” that they are used as intended for medical or illness related expenses. An embodiment of this invention may provide assurance that the gifts are used in the manner the contributor desires.

An embodiment of this invention may save time from scavenger hunting online and in brick and mortar stores for products and services that patients may need during their home health and medical care. Locating a product may be challenging, let alone vetting it for quality and price. Additionally required may be document management and reporting back to interested parties such as oncologists, radiologists and other care givers that need to be made aware of medical, health and or unrelated goods and services that may negatively impact a patient's well-being. This may occur at a time when time is precious and fighting for medical “reimbursement” may be not only consuming but stress inducing, this stress alone can negatively impact treatment, and recovery. One box, one receipt, with multiple copies to be provided to those who would aid in the knowledge of these goods, including expense management, IRS reporting, medical record keeping, etc.

In addition to time savings, an embodiment of this invention may offer financial solutions that help patients afford what they need or like during their course of treatment. Having products and services available may make it more likely that the patient will complete or be compliant with their treatment regimen. Third parties, such as friends and family, may have the ability to relieve patients from overwhelming financial burden, by contributing fixed dollar amounts to specific goods and or services, such as chemotherapy or prescription drug co-pays or to a general contribution. A “medical” registry and/or a portable “registry” may be provided such that patients may take to healthcare, retail and other paid for service or goods providers. Contributors can specify their desired use of proceeds, ensuring that their gifts are used in the manner in which they were given. An embodiment of this invention may be a combination of social media, flexible spending and web integration to existing FSAs allow for only employee or government sponsored participation, or self-payment. Third party contributions may be against the law, based on HIPAA and healthcare systems inability to identify “patients” outside of their own system. Giving a patient/customer a flexible mechanism, i.e., card, acceptable by any commercially viable entity, but pre-paid by third parties, may negate the need for self-funding and/or co-pays. With financial support a patient may potentially be compliant with his/her course of care, i.e., if they can pay for their medicinal needs, using third party funds, they may actually buy and use them to their restoration of health or in health maintenance. With enough financial support, rather than a patient abandoning chemo or radiation in treatment month 15 of 20, for example, they may be able to complete their course of care. The likelihood of them returning to the system, in worse medical condition, months or years later, may be negated. Not only may a burden be taken off of the financial system, but the healthcare system as well.

In one embodiment of the invention, a goal may be to give time back to individuals with an illness. In one embodiment, the invention may remove guesswork out of a search process by aggregating “best in class” products and services to provide an extensive, but consolidated collection. Another goal may be to streamline the selection process. Products and services may be bundled by treatment type, reducing typical searches from, for example, 5 hours to less than 30 minutes. In another embodiment, ecommerce solutions (e.g., electronic shopping cart) may be integrated and may be created by a patient and reviewed a doctor, nurse, patient navigator, healthcare provider etc. and managed throughout the course of treatment, as well as a locator tool for finding specialists (e.g., certified mammography centers, licensed prosthesis fitters, nutritionists and other local specialists) to enable customers to find reputable related services.

All the shipments may be “packed with compassion,” which means that each order may be beautifully and discreetly packaged. “One box, one receipt,” may be provided and providing multiple copies of your receipt for easier reimbursement tracking with insurers, tax-preparation, etc. A listing of ingredients for the products may also be included, saving valuable time and capturing otherwise unreported expenditures.

There may be strength in numbers and no one may know better than individuals who have used the products and services. Various disease communities may be known for support. An embodiment of this invention, may apply the community model to support individuals as they go through their journey with their particular illness. In one embodiment, the supplied community may be a multi-platform network, creating additional connections with and between customers.

A ratings system may be implemented, which may be a first for this category of care. Products and services, such as fitters, may be reviewed, rated and shared by patients and their caregivers, for example. Products may be supplied to complement, not conflict with a patient's course of treatment.

In another embodiment a registry may be provided. Customers may select needed and/or wanted products (e.g., home medical supplies) and services. Third-parties such as family, friends, community groups, foundations, product manufacturers, suppliers, etc., may purchase products and services from the registry and may generate financial support in lieu of books or flowers, etc, thereby funneling money from sympathetic yet unproductive gifts. Once a registry is created, a social media campaign (e.g., to notify family, friends, and groups) may be created on the customer's behalf to help raise contributions and fund mounting out-of-pocket expenses.

An embodiment of this invention may be designed to ease the personal and financial burden of disease management by removing the hassle, stress, anxiety, and trial and error associated with purchasing, for example, home health medical supplies. Customers may focus on themselves, family and treatment—not on distractions associated with finding, selecting and paying for items for their care. Though this invention, the customer may improve his or her state of mind.

### Illustrative Workflows

An embodiment of the invention may provide a computer system servicing needs of customers with a particular disease and/or disorder, comprising some or all of the following components:
A comprehensive catalog of specialized cross-category products and services selected to meet the needs of customers with the disease and/or disorder. The catalog may be a printed catalog or an on-line catalog. The catalog may be comprehensive in that it may include a broad spectrum of many different types of products and services (e.g., clothing, skin cream, bedding, massage, travel, real estate, etc.).
The catalog containing targeted products and services. The catalog may be targeted in that it may be directed towards meeting the needs of customers with, for example, a particular disease and/or disorder at a given time, stage or treatment cycle of the disease or disorder. The needs of a customer may include products and services required for personal health and/or wellbeing or in disease or multiple disease management. Wellbeing may include spiritual wellbeing or general contentment which may assist in disease management.
A plurality of secure personal registries containing products and services. A secure registry may mean the registries may be viewable only by the customer and customer indentified third-parties. The customer may select which third-parties can view the registry by sending an invitation to said third-party. An invitation may include a link (e.g., a URL) that may direct the third party to the customer's secure registry. When the third-party clicks the link the third party may view the customer's secure registry.
The products and services in the secure personal registries may be selected from the catalog by individual customers. A customer may select a product or service from the on-line catalog by clicking a button, a checkbox and/or an on-screen product image. When a product, or multiples of a product are selected for the registry, it/they may appear in the customer's registry until it is removed and/or purchased. The registry may include identifiers that are representations of the selected products and services.
The ability for experts and other third parties to recommend products and services for inclusion in the personal registry of one or more individual customers.
The ability for third parties to contribute funds to a personal registry, with or without purchasing a product or service. Third parties may contribute a monetary amount into the registry as a general contribution or the monetary amount may be tied to the purchase of specific products or services.
The ability to manage the relationship between the catalog containing targeted products and services, recommenders, and customers, while maintaining privacy of personal customer data. Privacy of personal customer data may be in compliance with federal and state rules and regulations requiring secure protection of personal and health information. Security may include prohibiting access to customer data from third-parties. For example, access to customer data may be restricted to customer and system administrators. In some embodiments, customer data that has had identifying personal data removed may be accessible to third-parties.
A notification of a monetary contribution or gift purchase may be made to the customer. A notification may be a message sent to the customer via email, SMS, text message, fax, etc. informing them of the third party actions.

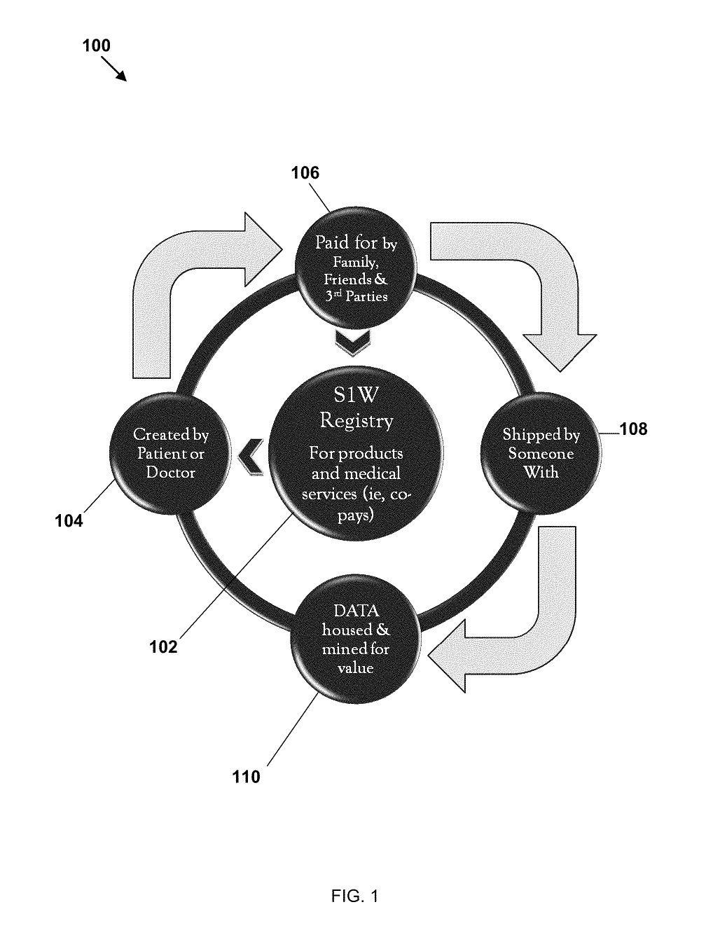

An example high-level workflow is shown in FIG. 1 100. A secure, general registry system including a select catalog of products and services, and private, personal individual registries 102 of the products and services (which may be referred to generally as products or items) may be provided by an embodiment of the invention. A personal/individual registry within the registry system 102 may be created 104 by a customer based on individual selections and/or from items in a “quicklist ” A quicklist may be created using the system by a third-party such as a doctor, healthcare provider, data analyzed within the computer system, etc, to bundle products together as dictated by their stage, or treatment cycle in their disease management. Items in the registry 102 may be purchased directly by the customer, by third parties (e.g., friends, coworkers, community groups, family members, etc.), or a monetary contribution by third parties may be made 106. Items purchased in step 106 may then be shipped to the customer in step 108. As products and services are requested by a customer and placed in the personal registry 102, additional contributions may be made 106, and the items may be shipped 108. By providing a mechanism of support, a customer may have the financial support to complete their costly medical treatments and prescription drug purchases, which assists with compliance of their medical treatment and yields a healthier person.

Data on which products are recommended, requested, purchased, and shipped, as well as ratings of the products and services may be stored and mined for value 110, and used to determine the content of the catalog, recommendations for personal registries, and medical information, while complying with the stringent privacy requirements that apply to personal health information.

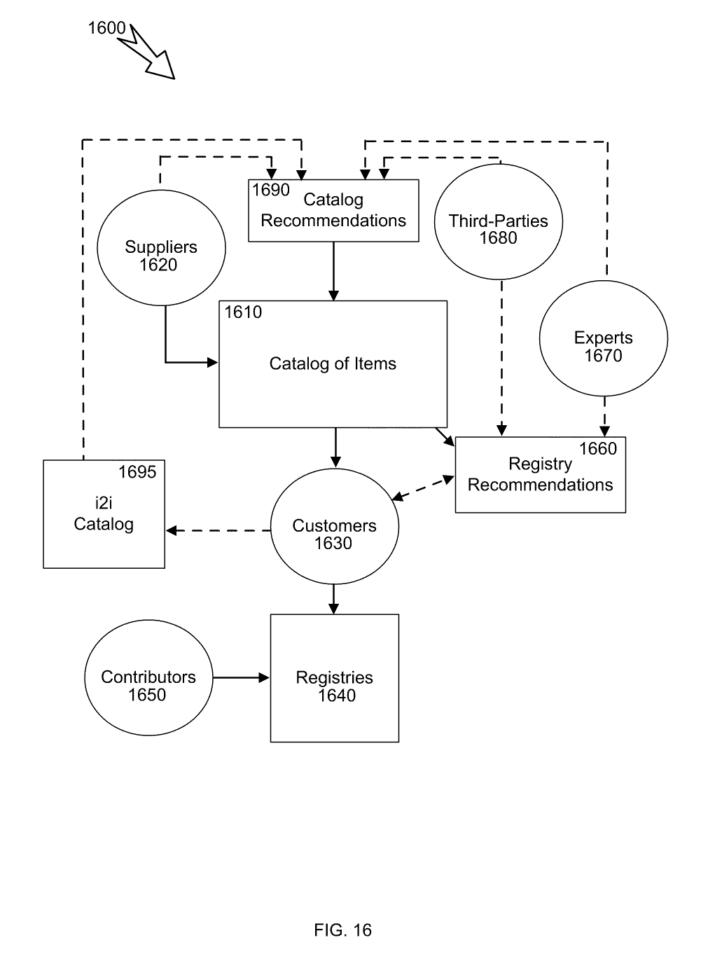

Another example high-level system flow diagram is shown in FIG. 16 1600. In an example embodiment, catalog of items 1610 may be created which may include specialty items (e.g., products and services) that may be targeted for a particular disease or disorder at a particular stage or treatment cycle. Items in catalog of items 1610 may be selected for their relevance to a particular disease or disorder at a particular stage or treatment cycle. For example, during the treatment stage for breast cancer, non-metallic deodorant (deodorants made with metallic ingredients may interfere with radiation treatments) may be an item in catalog of items 1610. Items in catalog of items 1610 may have been selected through roundtables of doctors and patients.

The items in catalog of items 1610 may be provided by suppliers 1620. Suppliers 1620 may include wholesale and retail distributors of medical items and providers of services. Customers 1630 may purchase from catalog of items 1610. Additionally, customers 1630 may select items from catalog of items 1610 for entry into registries 1640. Customers 1630 may include individuals suffering from the disease or disorder or entities associated with an individual suffering from the disease or disorder. Each customer in customers 1630 may be associated with a secure personal registry from registries 1640. A secure personal registry may be a collection of items chosen by a customer which is accessible only by the customer who created the registry or by entities selected by the customer who created the registry. In another embodiment, customers 1630 may be associated with multiple registries from registries 1640.

Contributors 1650 may contribute money or in-kind services to customers 1630 based on the selected items in registries 1640. Contributors 1650 may include, for example, friends, coworkers, community groups, foundations, employers, religious organizations, family members, trusts, etc. Customers 1630 may choose items for inclusion into their registries 1640 based on registry recommendations 1660. Registry recommendations 1660 may contain one or more items from catalog of items 1610. registry recommendations 1660 may be created from experts 1670, third-parties 1680, and/or customers 1630. Registry recommendations 1660 may also be referred to as quicklists Registry recommendations 1660 may allow customers 1630 to quickly select wanted items from the catalog of items 1610.

Suppliers 1620, customers 1630, experts 1670, and/or third-parties 1680 may make catalog recommendations 1690 for items to remove from or include with the catalog of items 1610. Catalog recommendations 1690 may also come from sales data (e.g., items that have low sales over a period of time may be selected for removal from the catalog of items 1610). Items from the catalog recommendations 1690 may be included in the catalog of items 1610 through the system.

In one embodiment, a crowdsourced product selection process may exist. The crowdsourced product selection process may be implemented using i2i catalog 1695, which may contain a large selection of items that may not be available for purchase. A link may be available that may allow customers 1630 to browse through categorized products and vote for items to be included in the catalog of items 1610. Once a pre-set threshold of votes has been obtained for an item in i2i catalog 1695, the item may be added into catalog of items 1610 and available for purchase or selection into registries 1640. For example, when an item receives the necessary number of votes the system may contact (e.g., email) our Chief Web Officer and VP of procurement to begin the process of negotiating with the product manufacturer. If an item becomes available for purchase, customers who voted for the item may be automatically notified that the newly acquired item is available for purchase or selection into registries 1640. The notification email may include links to voted on, in stock, items. Additionally, a link may automatically populate their ‘cart’ with all items they voted for so that they may go straight to checkout and purchase all of the newly inventoried items.

Customers 1630 may be encouraged to spend time browsing and voting for new items through the following. First, accessible items (e.g., items in i2i catalog 1695) may be listed under ‘similar items’ on various product level pages, so that customers 1630 reviewing and purchasing in stock items can see variations that may be added into catalog of items 1610. Customers 1630 may be able to vote for that product to be brought in straight from the product page they are currently viewing, Second, during checkout, customers 1630 may be offered immediate discounts on their current purchases for reviewing items (e.g., 20-30 items) and voting for items they would like to see included in catalog of items 1610. For example, when a customer agrees to participate, a new pop-up may display 20-30 items, then, they vote for the items they want and submit their ‘ballot’ at which point they may be returned to their cart with the discount already applied.

Data from flow 1600, including data on catalog of items 1610, suppliers 1620, customers 1630, registries 1640, contributors 1650, registry recommendations 1660, experts 1670, third-parties 1680, and catalog recommendations 1690, may be stored in a relational database. Data on customers 1630 may be maintained to comply with current state and federal regulations (e.g., HIPAA). Such compliance may include keeping personal (e.g., name, mailing address, etc.) information separate from other data (e.g., supplier 1620, experts 1670, etc.). The data from the relational database may be mined for value in compliance with the privacy of the personal customer data.

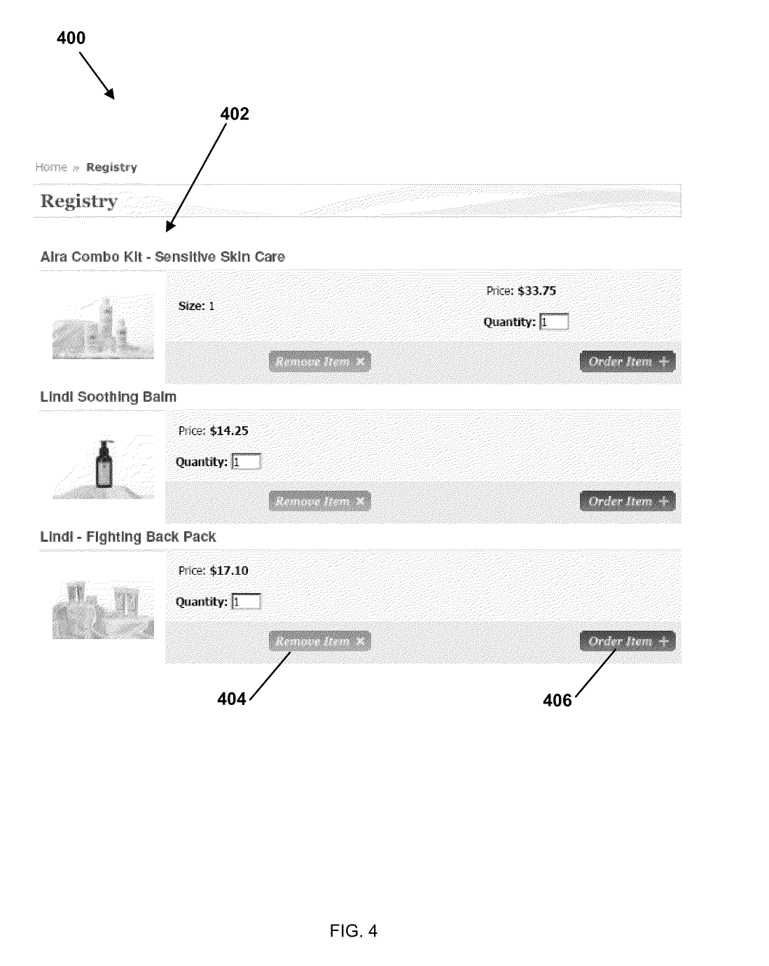

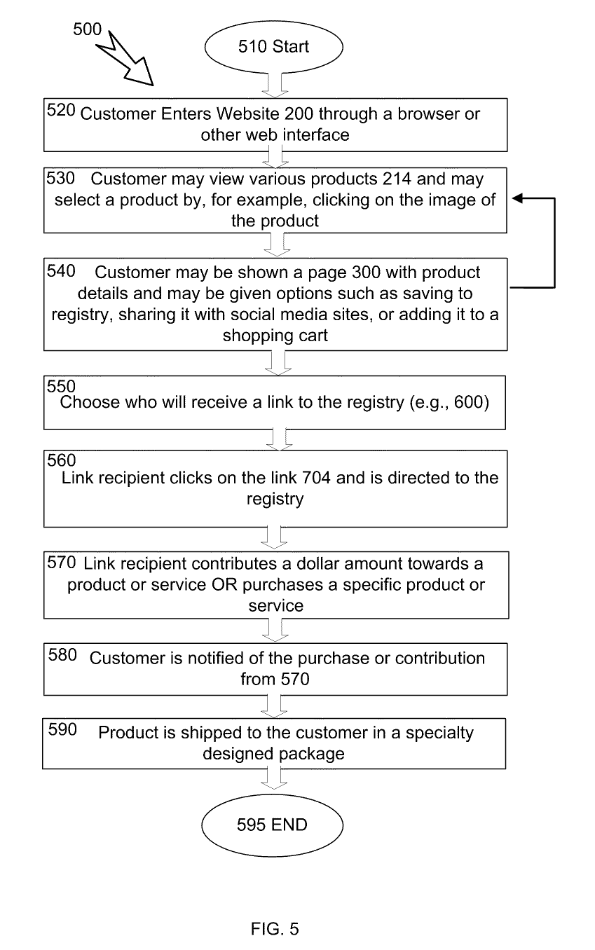

An illustrative workflow as shown in FIG. 5 500, may begin at start 510. From start 510, flow may move to 520 where a customer may enter the website 200. At 520 a customer may log into their web account, for example, through account registration. In one embodiment, a customer may be automatically logged on into their account. From 520 a customer may move to 530 and view the various products and services 214 on the website 200. In 530 a customer may select an item (e.g., click on image) and move to 540. At 540, a customer may be shown a product page 300 with details on the selected product 304. A products and services page 300 may have three buttons: “Add to Cart” 310, “Add to Registry” 312 and “Share” 314. If a customer wishes to register the item a customer may select the “Add to Registry” 312 option and the product may be saved into a registry 102, FIG. 4 400. In an alternative embodiment, products and services 214 may be added to the registry 102, 400 from a Multiple Add to Cart button. In some implementations, products and services 214 may be added to the registry 102, 400 in bulk.

The flow may repeat back to 530 to choose more products and services 214. The customer may also be able to prioritize the selected products and services 402 so that the higher priority products and services may be purchased before the lower priority products and services. From 540, flow may proceed to 550. At 550 a customer may choose how and who should know about the customer's registry 102, 400. A customer may be given several options; for example, email the page link 600 or an embodiment of the invention may manage a social media campaign, for example, on the customer's behalf. Such a campaign may let those who are identified by the customer and interested in supporting the customer know about the registration. Only chosen contacts may have access to the customer's individual registry 102, 400. In another embodiment, within the registry 102, 400 a web template 600 may be displayed to “tell people about your registry—email them this link,” for example. The link may allow a contributor to access the registry 102, 400 without searching or logging in. The registry 102, 400 may be, for example, cookie based yet still comply with, for example, HIPAA.

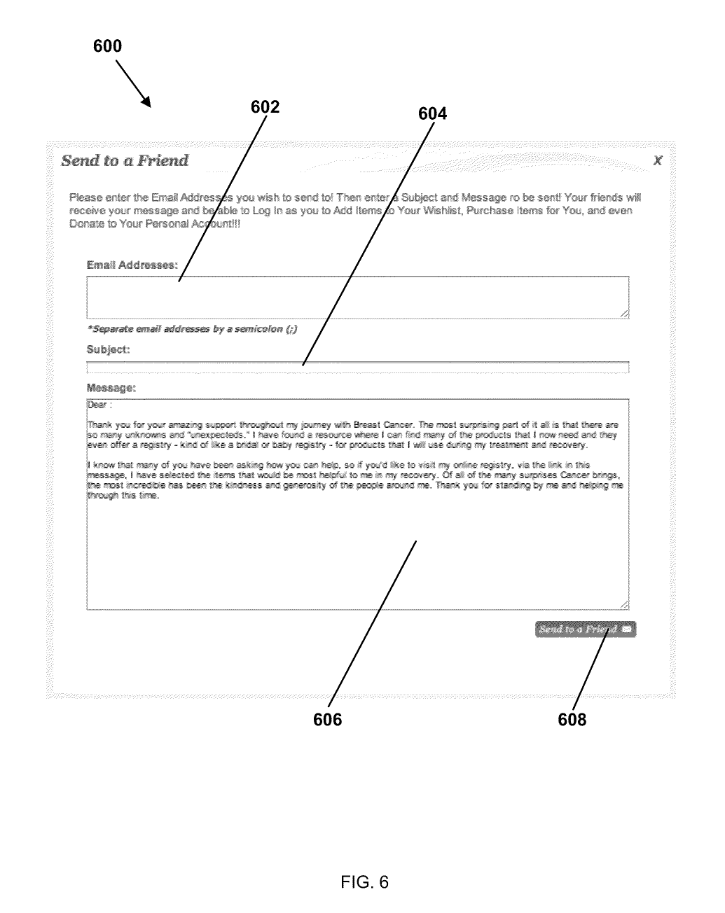

The customer may use a built-in email type system similar to that of, for example, Send to Friend, where a “send email” page is supplied as shown in FIG. 6 600 and the customer may send one or more links off to chosen recipients 602, or alternatively the customer may go into a third party email system (e.g., Gmail, Hotmail, Outlook, etc.) and send one or more links off to chosen recipients. The system may enter in suggested subject line 604 and message 606 for the customer to edit. Alternatively, the customer may be responsible for entering the related subject line 604, message 606, and all of the email addresses 602. A custom link 704 may be included with the email so that recipients could click the link and be logged right into the gift registry 102, 400 without additional steps.

In one embodiment, each initial recipient of emailed link may receive a slightly different formatted link. The emailed link, for example, may only be used by the first person to click on the link. As only the first person to click on the link may use the link, such a system may, for example, prohibit unwanted individuals from accessing the customer's registry 102, 400 (and potentially infringe HIPAA) even if the original email recipients forwarded the original email containing the link to secondary recipients.

A contributor with a valid link may not email additional links to additional individuals without, for example, permission of the customer. The customer's registry 102, 400 is not searchable by standard, outside search engines (e.g., Google, Bing, Yahoo, etc.). Contrary to the current registry model (e.g., Amazon's wish list, bridal registries, etc.) a customer's registry 102, 400 may be private and secure with restrictions designed to prohibit parties that have not been specially invited from viewing the customer's registry 102, 400.

In another embodiment, the system may store and associate the email addresses the customer has emailed. In the event that a potential contributor is having trouble retrieving the customer's registry 102, 400, the system may verify the potential contributor was indeed sent a link based on the email. Or, the system may resend a registry link to the stored and/or verified email address.

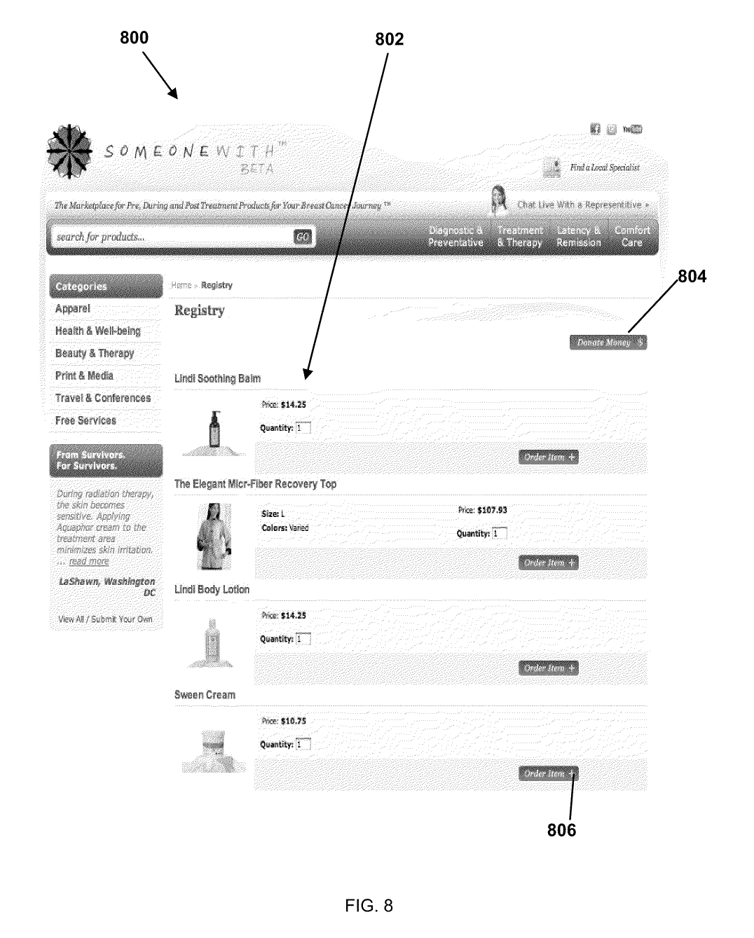

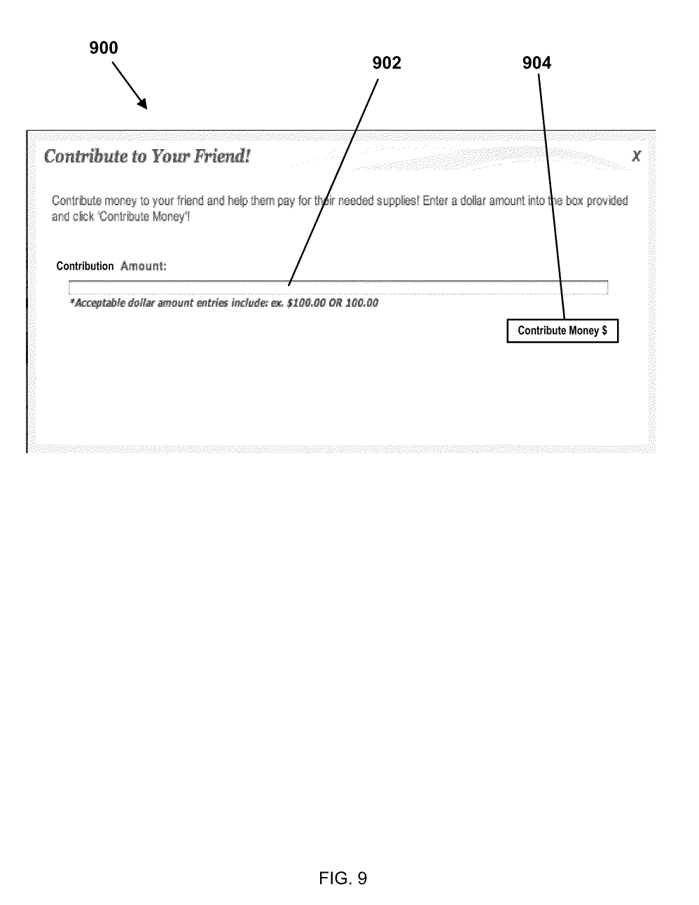

From 550 flow may proceed to 560 where a recipient of the link clicks on the link and is directed to the registry 102, FIG. 8 800. From 560 flow may proceed to 570, where the link recipient may contribute a dollar amount FIG. 9 900 toward the cost of a product 300 or service on the customer's registry 102, 800 or may purchase a specific product or service off the customer's registry 102 800. From 570, flow may then proceed to 580, where the customer may be notified (e.g., via email) of the gift from the consumer. From 580, flow may proceed to 590, where once the product from 570 is purchased, the product is shipped to the customer in a beautifully packaged, discreet, box. From 590, flow may then end at 595.

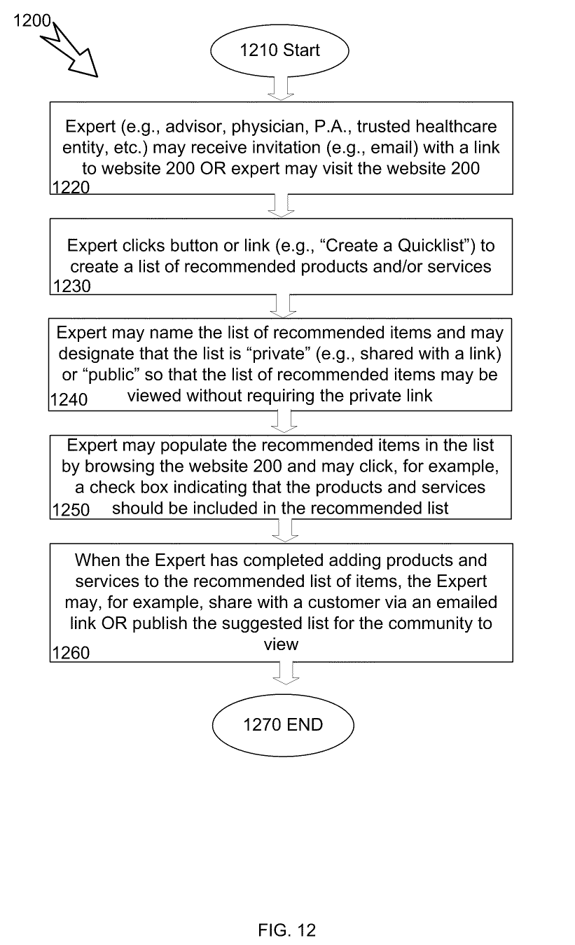

Another illustrative workflow as shown in FIG. 12 1200 which depicts a flowchart of how an advisor may create a quicklist in an embodiment of the invention. Flow may begin at start 1210. From 1210 flow may move to 1220 where an advisor or expert (e.g., prior user, doctor, healthcare personnel, vendor, etc.) may access the system. The expert may have received an invite through, for example, an email link. From 1220 flow may move to 1230. In 1230 the expert may click a button or link to create a quicklist of recommended products and services. A quicklist may supply the customer with an easily accessible list of products and services that may be selected for purchase or for placement within the registry. The following types of quicklists may exist in the system: (1) doctor (or healthcare) created quicklists, (2) customer created quicklists, (3) third-party quicklists, or (4) system generated quicklists based on system intelligence, recommendations, previous purchases, stage of illness, treatment cycle, etc. Customer created quicklists, may be created from, for example, recently selected products and/or services. From 1230 flow may move to 1240. In 1240 the expert may give the quicklist a name and may designate the quicklist as either public or private. If the quicklist is private, then only specified customers may view the quicklist Customers may receive a link to access the quicklist or may be given access through the system. If the quicklist is public, then all customers may view the quicklist From 1240 flow may move to 1250. In 1250 the expert may populate the quicklist with one or more items by browsing through the offered products and services and selecting those products and services for inclusion in the quicklist Selection of the products and services may be made through a checkbox or other selection indicator. From 1250 flow may move to 1260. In 1260 the expert may have completed adding products and services to the quicklist and the system saves the quicklist From 1260 flow may end at 1270 end.

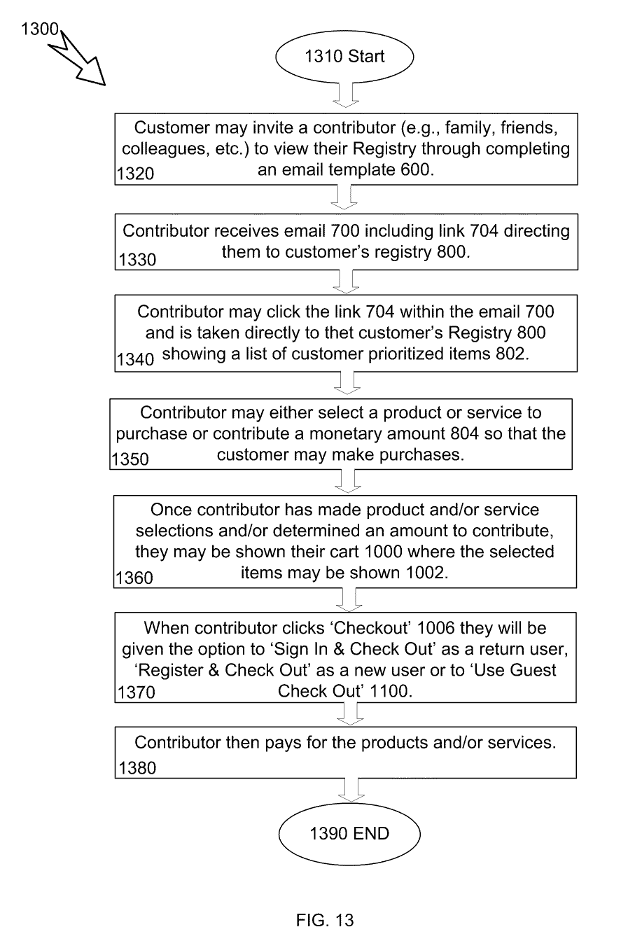

Another illustrative workflow as shown in FIG. 13 1300 which depicts a flowchart of how a contributor may use an embodiment of the invention. Flow may begin at start 1310. From 1310 flow may move to 1320. In 1320 the customer may invite at least one contributor (e.g., a third-party, family, friends, colleagues, etc.) to view the customer's registry 800 through completing an email template 600. From 1320 flow may move to 1330. In 1330 the contributor may receive an email such as that shown in 700 which may include a link 704 which may direct them to the customer's registry 800. From 1330 flow may move to 1340. In 1340 the contributor may click on the link 704 from the email 700 and may be taken directly to the customer's registry 800. In some embodiments, the contributor may be required to enter login information or may be automatically logged in. The customer's registry may show a list of customer prioritized items 802. In alternate embodiments, the customer may personalize or customize a contributor's view. For example, the contributor's view that has been customized may display a personalized message or messages or display only certain registry items (e.g., display only Kosher items, display only organic items, display only items less than a certain amount, display items exceeding a dollar amount, etc.) The contributor view 800 may vary from the customer view of the registry 400. For example, the customer may see contribution amounts and registry items, while the contributor may see the registry items without the total contribution amounts from all contributors. Also, a contributor may be given the option to make a contribution 804. A session flag may be used to specify various view, for example, either a customer or contributor views.

In one embodiment, third-parties may be able to purchase products, services, or make a monetary contribution for customers based on certain customer criteria volunteered by them in order to access said benefit (e.g., located in a certain area, have breast cancer, particular ethnic group, income level/financial status, etc.). This type of contribution may be done without access to a customer's registry.

From 1340 flow may move to 1350. In 1350 the contributor may select a product or service to purchase for the customer or may contribute cash as shown in 804, 900. With a cash contribution, the customer may choose (or has previously chosen) which products and services to purchase. In one embodiment, if a general monetary contribution was made, the system may automatically apply the contribution to the highest prioritized product or service on the customer's registry 400. If the customer has enough funds, the product or service may be purchased and shipped to the customer. Several products and/or services may be purchased and shipped depending on the amount of the contribution and the remaining money in the customer's account. In alternate embodiments, the contributor may make a general monetary contribution or one or more monetary contributions towards a specific item or items or towards a specific category of items (e.g., the money can only be spent on nutrition/fitness related services). If a contribution is made to a specific item, for example, the customer may only use that particular contribution towards that particular item. A running tally of contributions may be kept within a database or application 1510. This may be used in the confirmation page later to deduct during purchases, as well as when contributors contribute to the customer on their gift registry page.

A contributor may also purchase one or more services for the customer. Where a physical product is not purchased, several methods may be used to notify the customer of the purchase. The customer may receive a notification (e.g., via email, mail. Fax, etc.) that a particular service was purchased for the customer. Such notification may include, for example, a gift certificate or specialized card that the customer may present to receive the service. In one embodiment, a special credit card (e.g., VISA®, MASTERCARD®, AMERICAN EXPRESS®, etc.) which may only be used for specific purposes may be delivered to the customer. The specific purpose may be defined for example, by only allowing purchases for services with an identified Merchant Code, or in time, SIC or NAICS code or codes. The customized card may itself be a product for sale from the products and services 214.

From 1350 flow may move to 1360. In 1360, after the contributor has made product and/or service selections 802 and/or determined an amount of money to contribute 900, contributors may be shown a cart 1000 with their selected items 1002. From 1360 flow may move to 1370. In 1370 the contributor may have clicked the checkout button 1004 and a webpage 1100 may be shown which offers several checkout choices. The checkout choices 1100 may include, for example, ‘Sign In & Check Out’ as a return user 1102, ‘Register & Check Out’ as a new user 1104, and/or to ‘Use Guest Check Out’ 1106. From 1370 flow may move to 1380. In 1380, the contributor may have selected an appropriate button 1102, 1104, or 1106 and a payment screen may be displayed to capture payment information. If a contributor purchased products or services or contributed money, the contributor may begin a checkout process. Once a contributor begins the checkout process, their ship to information, for example, may be populated with the ship to information for the customer associated with the gift registry 102, 400. The session information, for example, may be used to pull the customer mailing address. The billing address may be that of the contributor. From 1380 flow may move to 1390 and end.

In another embodiment, after a monetary contribution is made the following may happen. The customer associated with the gift registry 400 may see a dollar value associated within their registry 400. The customer may, for example, select an item or group of items from the registry 400 to purchase and add them to an electronic shopping cart. Once the items are in an electronic shopping cart, because they are logged into their account and have money contributed to it, they may see an option to “checkout with contributions.” The electronic shopping cart total may reflect the amount of the order minus the amount of contributions applied. If, for example, the contribution amount is greater than the total, only the amount needed to make the purchase may be applied, however, if the amount of contributions is less than the order total, credit card information, for example, may be required on the shipping and billing page to make up the difference and complete the related order. The ship to and bill to addresses may be populated automatically from previously entered data. The customer may get a confirmation page which displays the order amount. The order amount may be deducted from the contributions total for that gift registry 400, and the purchased items may be removed or crossed off from the list.

In the event that products and services are no longer needed (e.g., the customer fully recovers or suffers a catastrophe) and money is still in the registry 400, the money may not go directly to the customer but may instead be given to a selected charity or the money may be distributed to other similarly situated customers, for example. Every attempt may be made to locate and contact the customer but after an excessive period of time (e.g., 18 months) any residual money in the customer's account may be distributed according to the wishes of the customer, for example. In some situations, a contribution may be considered a donation depending on the recipient.

### EXAMPLE EMBODIMENTS

In an exemplary embodiment of the invention, one purpose may be to direct people who genuinely ask and want help to bridge the gap between what you need and what you want (e.g. a $3,000 human hair wig). A customer, for example, may be diagnosed with a disease or disorder. The customer may wish to purchase or have purchased one or more specialty products and/or services designed to increase the quality of life for the customer. These products and services may be selected from a comprehensive catalog of relevant products and services related to the customer's need associated with a particular disease or disorder faced by the customer at a particular stage or treatment cycle of the disease or disorder. In other words, the offered products and services may be targeted towards individuals with a particular need. The offered products and services may change as the individual's needs change over time as treatment or the illness progresses. Such a service may significantly reduce the amount of effort and time required by individuals with needs to find products and services that may enhance their quality of life.

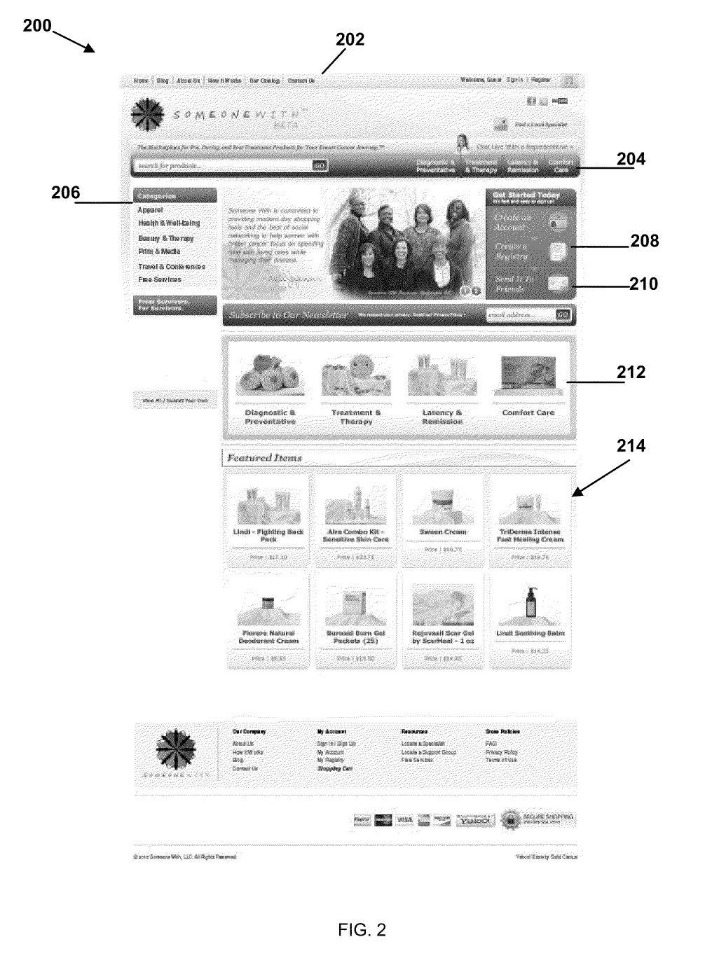

A first step may be to visit a home page FIG. 2 200. The home page 200 may display, for example, a wide range of home health products and medical supplies 214. An embodiment of the invention may have drastically reduced the long hours of searching by aggregating the “best in class” products 214 and then bundling them based on varying treatment types 204. For example, a customer that has been diagnosed with an illness (e.g., breast cancer, prostate cancer, lupus, arthritis, heart disease, autism, multiple sclerosis, sleep disorders, migraines, etc.) may be shown particular products and services 214 designed to increase the customer's comfort and quality of life at each particular stage of the illness (e.g., preventative, discovery, diagnosis, treatment, therapy, latency, remission, recovery, comfort care, etc.) or treatment cycle (e.g., chemotherapy, radiation, surgery such as mastectomy or lumpectomy, etc.). Such stages or treatment cycles may be selected using, for example, the stage navigation bar 204 or sample stage products 212. In the case of breast cancer, for example, various products may include, for example, breast forms, specially designed bras, medical support garments, prosthetic designed skin care products, specially designed headwear and turbans, specially designed swimwear, relevant books, etc. In addition to specially designed products, services in-kind may also be offered. Services may include, for example, pet care, prosthetic fitters, specialists, travel, home cleaning, cooking, meal delivery, pet finder, babysitting, driving, carpooling, real estate (e.g., eldercare, hospice, house swaps for people with illnesses, vacation houses, tax deductible houses, etc.), yard work, sponsor a day of co-pay, gift cards, massage, etc. Various categories (e.g., apparel, health & wellbeing, beauty & therapy, print & media, travel & conferences, free services, etc.) may, for example, be selected using the categories navigation menu 206. Video tutorials may also be provided on for example, how to use a product or how to measure yourself for a product. The selected services may be considered candidates for their registry, on behalf of the customer. The home page 200 may also have a top-level navigation bar 202 for navigating to pages such as home, blog, about us, how it works, catalog, contact us, etc. A registry 102, 400 may also be created from this page by, for example, selecting the “create a registry” button 208. The registry 102, 400 may be sent to a third party, via, for example, a “send it to friends” button 210.

Supplied services may also align free or complementary services (e.g., maid services) which may be offered by companies to those with particular disease or disorder. Requesting free services may be cumbersome and tedious with multiple forms and applications to complete. In one embodiment of this invention, the system may assist in completing requests for these services by assembling the required forms and the system may automatically insert information known by the system into the forms. In another embodiment, the system may match individuals with particular needs with individuals or entities that wish to contribute (e.g., national or local not-for-profits or foundations, dog walkers, hair for wigs, wig makers, quilts, etc.). The system may also match qualified customers with services that may fit the customer's particular needs. For example, the system may provide matching for customers with low or no insurance with companies and groups that may provide free products or services (e.g., Avon gives free mammograms for individuals with low or no insurance). In other words, the system may be able to coordinate foundations with individuals who qualify for a grant, an entirely manual and tedious process today.

Family and friends may offer support for pre, during and post treatment cycles, other organizations, foundations and entities may also offer support. Free and/or discounted services may exist for those battling cancer and other diseases or disorders.

For example, free wigs, breast prosthesis, and medication co-pay assistance are offered by the American Cancer Society and Cancer Care, Network of Strength offers a wig and prosthesis bank, The Red Devils, offer local house cleaning, transportation to and from doctor appointments, and meal preparation. Mfeast offers free meals and nutritional advice for breast cancer and AIDS patients and survivors. Sirens for Survivors offers free professional photography sittings around the country. INK-B-GONE offers a program to help breast cancer survivors remove skin colorations left by radiation and chemotherapy. Lastly, many hotels and travel destinations offer discounts for free services for individuals suffering from diseases or disorders. These offered services are compassionate and valuable to each person they serve.

However, individuals suffering from a disease or disorder may have difficultly. in finding these services. Additionally, once a service is found, the application may be tedious and may require constant monitoring, Each organization may have their own criteria for giving, their own applications and approval processes, and many are small organizations without high-tech approaches to submitting an application. For example, some organizations may require proof of your diseases or disorder in the form of a “letter of medical need,” financial information, and/or income information. These applications (i.e., “forms”) may be time consuming and often, when taken altogether, overwhelm customers who may abandon their efforts in applying for such valuable services. The applications may cause additional frustration and confusion and may not guarantee the service or offering.

In an example embodiment of the invention, a consolidated manner in which to apply for services (e.g., free and discounted services) may be provided by pre-populating the customer's selected application forms, all at once. Additionally, the application forms may be automatically identified based on the service selected. The paper application process may be made electronic for ease of filing. Fields on the forms may be populated with information drawn from stored customer information. Fields may be highlighted where the information required cannot be located in the customer's account. Information entered by the customer may be saved for future use and applied to future applications if needed. Once the form is complete, the form may be filed with the entity. is may make it possible for customers to apply for services, in volume, hassle-free.

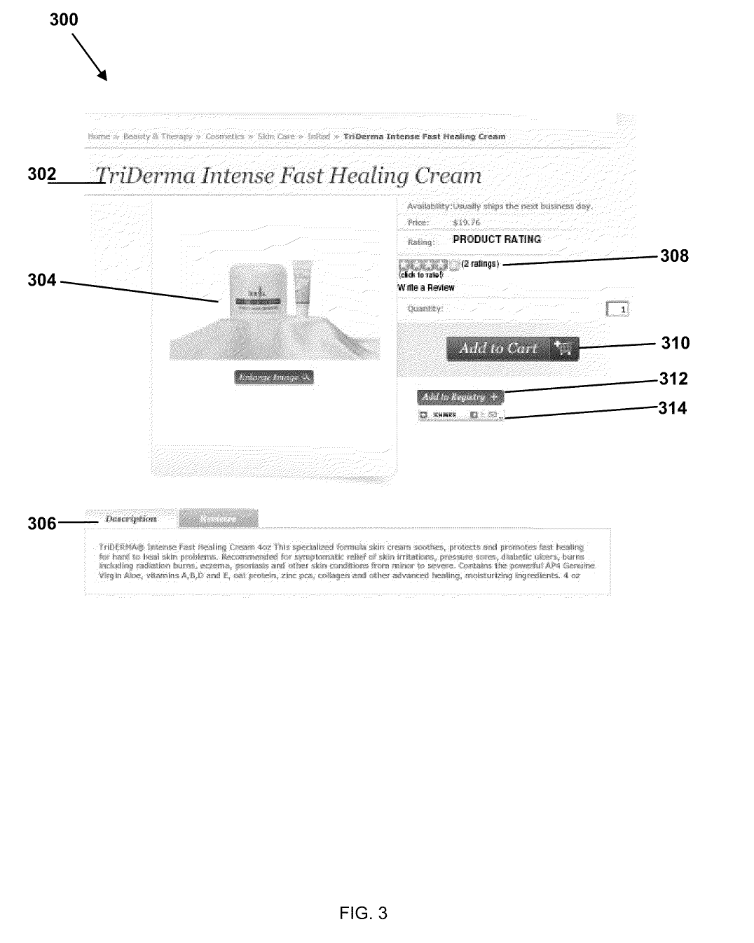

FIG. 3 300 depicts an illustrative product page. FIG. 3 300 may be displayed when a product or service 214 was selected by clicking on a product or service image. On the product page 300, product title 302, product image 304, product description and review 306, and product rating 308 may be displayed. Selected products may be placed in your customized shopping cart or registry by clicking on the “Add to Cart” button 310 or “Add to Registry” button 312, respectively. A “Share” button 314 may be displayed which may allow the customer to share the item with various social media websites.

FIG. 4 400 depicts an illustrative customer registry page. The products and services 402 shown may represent products and services selected by the customer for their registry. Products and services 402 may be ordered by selecting, for example, the Order Item button 406. Products and services 402 may be removed from the registry by selecting, for example, the Remove Item button 404.

FIG. 6 600 depicts an illustrative webpage email template that may be used to notify friends, family, and/or third-parties (e.g., contributors) that a registry has been created and that contributions may be made. Email address field 602 may allow entry of one or more email address for contributors. Other embodiments may allow additional communication addresses for contributors such as IP address, telephone number, and/or postal address. Subject field 604 may be text editable by the consumer and may allow entry of a subject for the communication. The subject field 604 may be populated by the system with a sample subject which may be editable by the customer. The body field 606 may be customized by the consumer. The body field 606 may be populated by the system with a sample message for the contributors which may be customized by the consumer. When the email is complete, the customer may select 608 to transmit the email to the contributors.

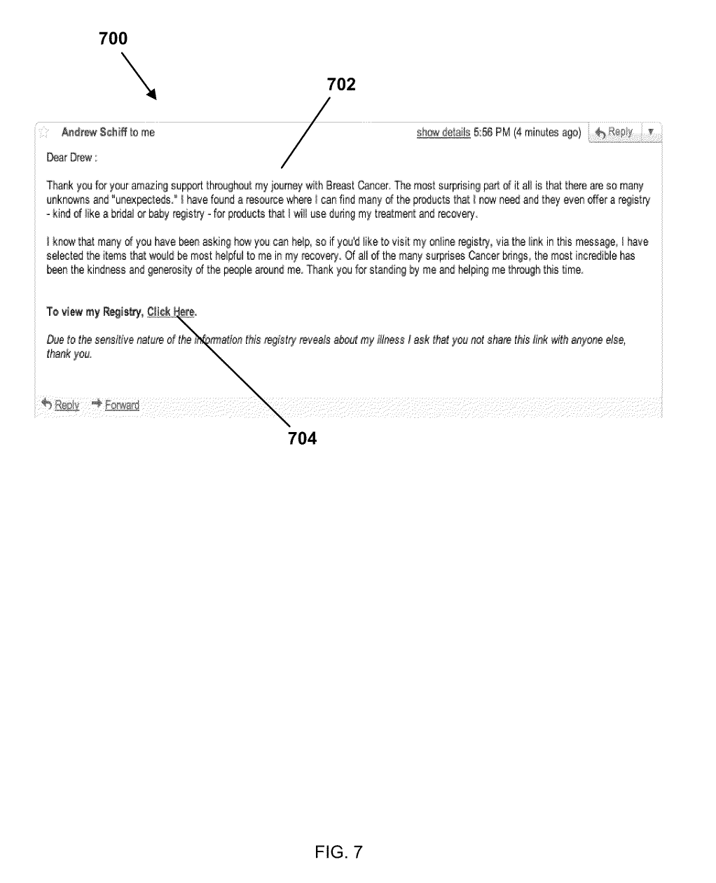

FIG. 7 700 depicts an illustrative email received by a contributor. A contributor may receive email such as that depicted in 700. The email 700 may have a standard or customized message 702 from the customer. The email 700 may also have a registry link 704 that may take the contributor to the customer's customized secure registry 800.

FIG. 8 800 depicts an illustrative registry page for a contributor. A contributor may use webpage 800 to contribute to the customer. A contributor may purchase items or services 802 for the customer. A contributor may also contribute a monetary amount for the customer by selecting a button such as a “Contribute Money” button 804. The monetary amount may be used by the customer generally or for specific contributor identified products and/or services. The specific contributor identified products and/or services may be listed on the registry or the contributor may be able to select specific categories to contribute towards (e.g., co-pay, acupuncture, prescription medicine, over the counter medicine, etc.).

FIG. 9 900 depicts an illustrative monetary contribution page. Amount field 902 may allow the input of a monetary contribution amount. Once an amount is entered in the amount field 902, a Contribute button 904 may be pressed to confirm the monetary amount contributed.

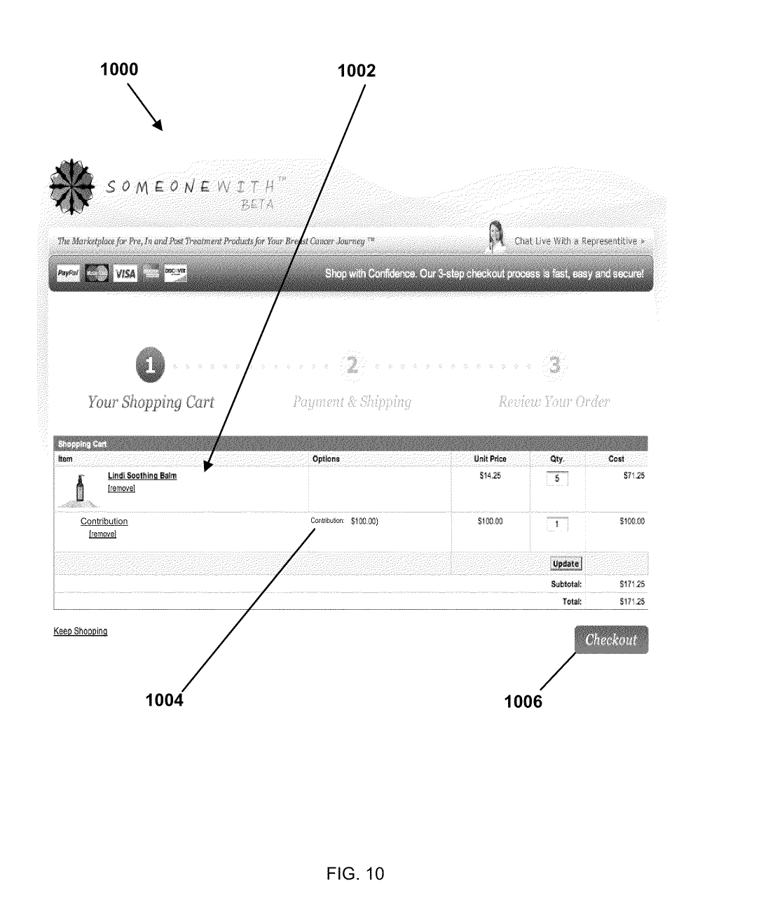

FIG. 10 1000 depicts an illustrative shopping cart. The shopping cart 1000 may depict products and services selected for purchase 1002 including a monetary contribution amount 1004. Pressing the Checkout 1006 button may confirm that the products, services and contribution amount 1002 wish to be purchased.

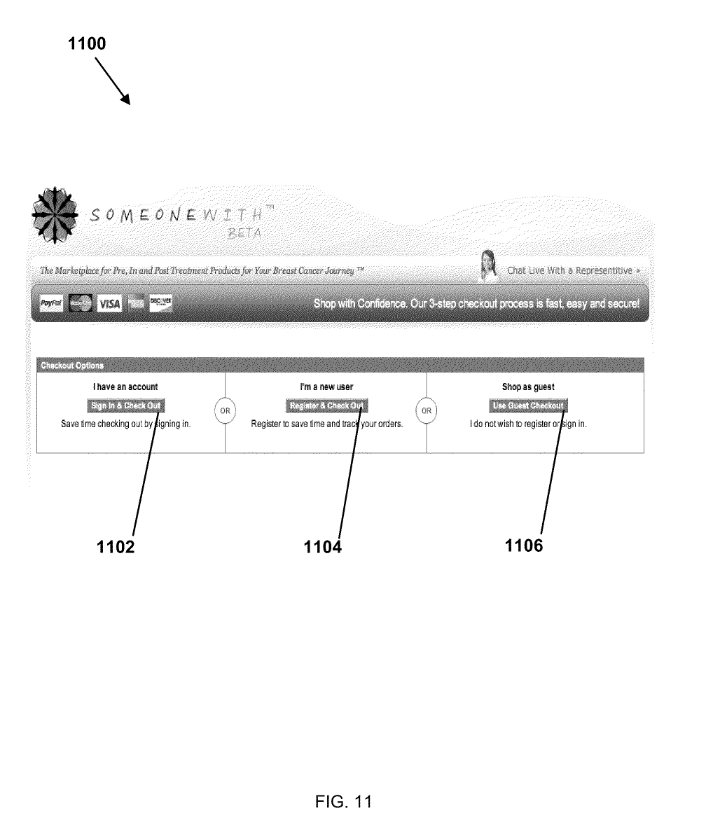

FIG. 11 1100 depicts an illustrative checkout options page. To purchase products, services, and/or monetary contributions, a contributor may have the following options. If the contributor has a current account the contributor may select Sign in and Checkout 1102. If the contributor is a new user, the contributor may select Register and Checkout 1104. If the contributor does not wish to setup an account, the contributor may select Use Guest Checkout 1106. In alternate embodiments, the contributor may be automatically logged in.

An embodiment of the invention may include sections with advice (e.g., prior users, survivors, doctors, healthcare providers, vendors, certifying bodies, etc). The offered products and services 214 may be rated, reviewed and shared by customers, patients, and/or caregivers allowing a customer to benefit from the knowledge and experiences of other individuals. Customers may be asked to rate 308 and review 306 any items that may have been previously used (regardless of where the item was purchased).

The system may be self-governing in that the provided products and services 214 are determined from the collective input of customers. For example, the products and services 214 may be rated 308 by customers and/or third parties. New products and services may be added to the offered list of products and services 214 if requested by a number of customers. Alternatively, products and services may be removed from the offered list of products and services 214 if the items and services receive low ratings. The products and services 214 may be rated by customers or users of the products and services. Customers or users of the products and services are encouraged to, for example, supply their thoughts and experiences with the product or service. In another embodiment, the products and services may be rated by doctors. A doctor rating may include a video or voice or written statement. Furthermore, the doctors themselves may also be rated by the customers.

Products that are not yet introduced into the product line 214 may be presented to existing customers for a vote. If the potential product receives enough votes, for example, it may earn a place in the product line 214 and customers may then add the product to their registry 102, 400 and/or purchase the new product.

With the products and services 214 rated and reviewed, an embodiment of the invention may give a customer confidence that the selected products are indeed essential to, beneficial for and not in conflict with a current course of care, for example. Prior to purchasing any items 214, a customer may have the option to send your cart to a healthcare provider (e.g., oncologist) for approval (e.g., approval of the product ingredients), ensuring that the products fit a specified treatment regimen. Once a customer is ready to place a order, the customer may check out online or the customer may have the option to move some or all of the selected items to into a personal registry FIG. 4 400. Unlike current retailers, a customer may not receive multiple shipments from various retailers. The items may be packed in (beautifully packaged) box or boxes, with one receipt. Multiple copies of the receipt may be provided for assisting with, for example, facilitating reimbursement tracking with insurers, tax-preparation, etc, saving valuable time and capturing what could inadvertently be unreported expenditures.

The registry 400, may allow a customer to select items 214 wanted or needed and move them into the registry 102, 400 so that, for example, friends, family, church groups, co-workers, etc (i.e., third-parties) can select a gift that you want or make contributions toward your purchases. Once items are in the registry 102, 400, items 402 may be removed by pressing a button such as the “Remove Item” button 404. Items 402 in the registry 102, 400, may be purchased or added to a shopping cart by, for example, pressing the “Order Item” button 406.

The system may contain a list of specialists such as, certified mammography centers, licensed fitters (e.g., Board for Orthotics/Prosthetic Certification (BOC) or American Board for Certification in Orthotics & Prosthetics (ABC)), nutritionists, wig/prosthetic maker, etc. If a customer requires a specialist, the customer may select the specialist type and enter the customer address (if not known already). Once the specialist type and customer address is entered into the system a list and/or map of specialists in the customer's area may be displayed. For example, the system may show the customer a list of specialists within a specified number of miles (e.g., 5, 10, 20, 50, etc.). In one embodiment, specialists that are highly rated or have an agreement may be highlighted when displaying a list of specialists to the customer. If the customer selects a specialist, driving directions to the specialist may be displayed, again, adding to time savings.

The system may allow a specialist manager, for example, to upload a list of specialists, locations, and their areas of practice (could be multiple specialties per specialist) into a system's admin panel, for example. This may include the ability to add individual and for example, comma separated values, upload of locations. In one embodiment, a specialist or specialist group may submit a list of specialists, locations, and their areas of practice and may be considered for listing. After a period of due diligence, for example, the specialist may be added to the list for their related specialties.

For example, if a customer requires a specialist (e.g., certified mammography center, licensed fitters, nutritionists, wig/prosthetic maker, etc.) the customer may need information about the specialist, including directions, types of insurance carried, hours of operation, areas of specialty, etc. The customer may be given a list of specialists in their area, such as by zip code, from which to choose. The customer may rate their experience with the specialist and upload this into a rating database that may be accessed by other users of that good or service.

In one embodiment, a customer may have been diagnosed with an illness. A customer may be made more comfortable when third parties contribute 106 (e.g., financially, spiritually, time, etc.) towards products and services 214 that may assist in comforting the customer. Furthermore, friends, family, co-workers, church groups, community foundations, contributors, etc, may feel better about the manner in which they contribute to a customer when they can be assured that any and all contributions may go towards a dedicated purpose (e.g., healthcare). The system supplied registry 102, 400 and contributions module for website use may provide assurance that a contribution to the customer is related to an intended purpose (e.g., healthcare, wellbeing, etc.).

The gift registration and contributions module may have, for example, multiple users. A first user may be a customer, for example, who may create a gift registry 400 using the system and accept contributions towards it. Another user may be a third-party associate of the customer (e.g., a friend, a co-worker, a family member, members of a religious community, members of a charitable organization, etc.) or other contributor who may purchase products or services from the registry 800 and/or may make a monetary contribution 900.

In an embodiment, third parties may also be able to create recommended quicklists For example, hospitals, doctors, or other healthcare providers may supply a list of recommended products and services. These recommended products and services may be incorporated into a quicklist Friends or associates may create a quicklist Additionally, the system may create an intelligent quicklist based on customer supplied information combined with product and service ratings. A consumer may have several quicklists to choose products and services from and may be able to select all items from the quicklist or select individual items for placement into the customer's own registry 400. The quicklist may be available to the customer based on information supplied by the customer such as the name of the customer's current doctor or hospital. Quicklists may greatly reduce the burden on the customer from tracking down the hard to find items. The system provided quicklist may compile the information provided from the customer's healthcare provider and provide optimized products and services.

Third parties, such as manufacturers, foundations, or community groups, may be able to provide products or services to the consumer by placing them, for example, directly into the customer's registry 400 or into a quicklist for the customer's selection. Manufacturers, for example, could then provide sample products to targeted customers with specific needs for particular products. Alternatively, products and services may be placed on the registry and gift certificate, gift card, or a special card may be issued to the customer, the customer may then receive the item or service from a particular store.

In another embodiment, a customer's registry 400 may be shown to a doctor or other healthcare provider to ensure the products and services listed are appropriate for the customer. Registry items may include a listing of all ingredients to assist with the determination whether the product is appropriate. The listing of registry items and associated ingredients may be printed easily. Additionally, products shipped to the customer may contain several printouts listing the ingredients. These printouts may be labeled for various entities, for example, for your personal records, for your doctor, for your pharmacist, for your insurance provider, etc. In one embodiment, the product list with detailed ingredient list may be automatically communicated (e.g., emailed, mailed, faxed, placed in electronic health record (EHR), etc.) to healthcare providers. The ingredients may be cross referenced with emergency medical records. The system may alert the customer of possible allergies or products that may not be complementary with current treatments or current ailments. In one embodiment, the customer may be alerted (e.g., via pop-ups, email, SMS, text message, etc.) about when or when not to take or use the products. In addition to the customer and health care providers, the ingredient list may also be communicated to potential customers, experts, manufacturers, or other third parties.

In one embodiment, the system outputs a comprehensive catalog of relevant products and services related to a customer's need associated with a particular issue faced by the customer at a particular stage which may be on-line or in print. The catalog, printed and/or on-line, may be customized for a particular healthcare entity (e.g., doctor's office, hospital, etc.) or the catalog may be customized to a target audience such as a men's catalog, youth catalog, Spanish catalog, etc. A kiosk may be provided to display the on-line catalog. The kiosk may have a telephone which may contact an individual associated with the system for instant customer service. The kiosk may display instructional videos (e.g., how to measure) or product videos. The catalog, printed and/or on-line, may also be targeted for specific locations such as women's centers, breast cancer centers, support groups, gyms, plastic surgeons, trade shows, conferences, travel (e.g., skymall). The catalog, printed and/or on-line, may be co-branded the same as the center where it is located for revenue sharing or donation or contribution. Further customization may include specific doctor choices and recommendations, doctor/healthcare professional photos, commentary from the doctor or healthcare professional (e.g., articles on products or diseases, category introductions, editorials, etc.). The catalog may be placed into specialty magazines (e.g., Health Monitor). The printed catalog's ratings may match the on-line ratings at the time of printing. The printed catalog may offer links for instructional videos (e.g., how to take certain measurements, product information, etc). Postcards with product testimonials may also be used. Also, recorded video personal testimonials may also be used with service or product demonstrations or experiences. The personal testimonials may be videos of individuals telling their stories (e.g., Amy, a seven-year breast cancer survivor).

Illustrations, such as CAD drawings, may be provided, which may depict sample office layouts which may be presented to clients like women's centers, oncology, rehab, doctor officer etc. The illustrations may Include TV, peninsular desk, and shelves to hold references like DVDs. The sample layout may be used at trade shows or a virtual layout may be provided to allow creation of the illustration onsite. The illustration may depict how an existing boutique/gift shop space may be transformed into a more efficient, virtual outlet using our online or in print product catalogs.

In another embodiment, the system may become a supplier of products for hospitals, stores or boutiques. The printed catalog may be customized for the store or boutique while providing a full suite of goods and services which the small store or boutique may not have been able to previously supply. The system may be part of the supply chain and provide, for example, buying power, better costs, point of sale, inventory control, central invoicing, a consistent look and feel, etc.

Another embodiment may guarantee the re-purchase or buy back of high cost items or purchased under consignment. The items that have been re-purchased may be refurbished and/or may be re-sold under an appropriate section of the website 200 or donated to appropriate individuals or institutions.

In another embodiment, in addition to the product ratings as described above, consumers of products and services may be measured or tracked for a period of time (e.g., daily, every three days, weekly, monthly, etc.). Measurements may include wellness, such as emotional, physical, fatigue, appetite, etc. The measurements may be tied to general wellness or specific clinical products for managing the collective feedback. Tracking could be provided for specific products and/or for clinical trials which may have specific monitoring questions. Measurements may be obtained from customers using, for example, an e-commerce rating engine, a podcast, via email, etc. The measurements may then be given to the manufacturer of the products, the provider of the service, or clinical trial operator to help enhance the product, service, or trial.

In another embodiment, the registry may be integrated into healthcare systems (e.g., doctor's offices, hospitals, insurance companies, pharmacies, etc.). By integrating the registry into the backend of healthcare systems, purchased items or services may be redeemed on-site through the registry 102. For example, if co-pay was purchased through the registry 102, the healthcare provider may receive payment through the registry 102 and not directly from the customer.

Although some of the above embodiments may be directed to breast cancer additional diseases or disorders may also be encompassed by embodiments of the invention. Additional diseases and disorders are addressed in the following paragraphs.

### Prostate Cancer

Other than skin cancer, prostate cancer is the most common cancer in American men. The latest American Cancer Society estimates for prostate cancer in the United States are for 2010:
About 217,730 new cases of prostate cancer will be diagnosed.
About 32,050 men will die of prostate cancer.
1 man in 6 will be diagnosed with prostate cancer during his lifetime.
More than 2 million men in the United States have been diagnosed with prostate cancer at some point are still alive today.
Prostate cancer is the second leading cause of cancer death in American men, behind only lung cancer.
About 1 man in 36 will die of prostate cancer.

An embodiment of the invention may be tailored to individuals dealing with prostate cancer issues. Prostate cancer survivors may find post-operative prostatectomy or radical prostatectomy challenges such as the need for compression like under garments, catheter/wound site cleaning/maintenance creams/gels/lotions, specialty clamps for urine leakage/incontinence and impotence. These unique products (e.g., incontinence clamps) may be in addition to the products needed to complement radiation therapy or other doctor directed therapies. The nature of the disease may create certain sensitivities and warrant discretion in purchasing items or services, supporting individuals, and/or getting advice from others who have been through this life altering disease. Advice may include post-operative sexual well-being and nutritional advice. An embodiment of the invention may include an aggregation method, rating/review system, and quicklists which may dramatically improve a customer's ability to find unique and niche products and to determine which products and services are right for them.

### Arthritis

An embodiment of the invention may be tailored to individuals with arthritis. Arthritis is inflammation of one or more joints which results in pain, swelling, stiffness, and limited movement. There are more than 100 different types of arthritis. It can occur in men and women of all ages. About 37 million people in America have arthritis of some kind, which is almost 1 out of every 7 people. Most are chronic (e.g., long-term) conditions and the goal of treatment is to control the pain and minimize joint damage. Chronic arthritis frequently goes in and out of remission.

Osteoarthritis is the most common type and is more likely to occur as people age. It may be felt in any joint, but most commonly in hips, knees or fingers. In some autoimmune forms of arthritis, the joints may become deformed if the disease is not treated. Such joint deformities are the hallmarks of severe, untreated rheumatoid arthritis. Treatment of arthritis depends on the cause, which joints are affected, the severity, and how the condition affects the individual's daily activities. If possible, treatment will focus on eliminating the cause of the arthritis. In fact, making lifestyle changes without medications may be preferable for osteoarthritis and other forms of joint inflammation. If needed, medications may be used in addition to lifestyle changes.

In an embodiment of the invention, treatment categories may include exercise, joint support, rest and stress reduction, body positioning and mobility aids, and/or surgery and other interventions.

Exercise may be necessary to maintain healthy joints, relieve stiffness, reduce pain and fatigue, improve muscle and bone strength, and lose weight. An exercise program may be tailored to the individual and may include, for example, low-impact aerobic activity (also called endurance exercise), range of motion exercises for flexibility, and/or strength training for muscle tone.

An embodiment of the invention may include exercise products and services for arthritis. Products and services may include exercise videos, exercise equipment, mats, exercise bands, foam rollers, arthritis friendly weights, personal training services, personal trainer locators (e.g., via zip codes), physical therapy services, physical therapist locators (e.g., via zip codes), etc.

Joint support techniques may help support and correctly align joints. Joint support may be particularly necessary for rheumatoid arthritis. In addition to typical physical therapy, a physical therapist may also consider water therapy, ice massage, and/or transcutaneous nerve stimulation (TENS).

An embodiment of the invention may provide joint support products and services for arthritis. Products and services may include joint wraps, splints, hand and wrist supports, arthritis gloves, hot and cold mittens and foot wraps, heat wraps, compresses, carpal cuffs, splints, orthotics (e.g., service provider recommendation), capsaicin cream, heat spray, natural pain relief creams, therapeutic bathing salts, vitamins, minerals, nutritionists, cookbooks, glucosamine, chondroitin, and over-the-counter (OTC) anti-inflammatory medications such as Acetaminophen (Tylenol), NSAIDs (Aspirin, ibuprofen, or naproxen), etc.

Rest and stress reduction, (e.g., sleeping 8 to 10 hours per night and taking naps during the day) may help recovery from flare-up more quickly and may even help prevent exacerbations.

An embodiment of the invention may provide rest and stress reduction products and services for arthritis. Products and services may include neck support pillows, leg support pillows, bed wedges, body aligners, back support, nap mats, personal alarms, meditation, guided imagery, books, videos, services, Yoga, Thai Chi, etc.

Body positioning and mobility aids may assist in avoiding or recovering from an arthritic flare-up. Techniques may include avoiding holding one position for too long, avoiding positions or movements that place extra stress on affected joints, and/or making in-home activities easier.

An embodiment of the invention may provide body positioning and mobility products and services for arthritis. Products and services may include grab bars for the shower, tub, and near the toilet, cookware, tableware, dining utensils, kitchen openers, bathing aids, bathroom sitting and standing aids, grooming and hygiene aids, toileting aids, dressing aids, hair dryer stands, gardening tools, writing aids, big button TV remotes, grippers, adapters, holders, office aids, playing cards/holder, dressing aids, sitting, standing and walking aids, car mobility aids, gel cushions for sitting and standing, easy-to-use daily products, etc.

Surgery and other interventions may be required for individuals suffering from arthritis. In some cases, surgery to rebuild the joint (e.g., arthroplasty) or to replace the joint (e.g., a total joint replacement) may help maintain a more normal lifestyle.

An embodiment of the invention may provide products and services for arthritic suffers who have or are considering surgery or other interventions. Products and services may include previously-owned artificial joints, walkers, ice packs, compression stockings, hydration aids, incision coverings, foot and ankle pumps, toilet and shower supports, etc.

### Autism, Autistic Spectrum Disorders (ASD), Pervasive Developmental Disorder—Not Otherwise Specified (PDD-NOS), Asperser Syndrome, Childhood Disintegrative Disorder (CDD) and Rett Syndrome

Estimates for autism include the following:
Autism effects 1 in every 100 children.
Autism effects 1 in every 54 boys.
40% of autistic children do not talk at all.
25%-30% of autistic children have some words at 12 to 18 months of age and then lose them.
The lifetime cost for an individual with autism is estimated to be $3.2 million.
Autism costs the nation over $35 billion per year, a figure expected to increase dramatically in the next decade.
There is currently no cure for autism.
No one knows what causes autism.
In 20 years there has been more than a 600% increase in diagnosed cases of autism

The National Institute of Child Health and Human Development (NICHHD) explains Autism Spectrum Disorder as follows: “Different people with autism can have very different symptoms. Health care providers think of autism as a ‘spectrum’ disorder, a group of disorders with similar features. One person may have mild symptoms, while another may have serious symptoms. But they both have an autism spectrum disorder.”

Additionally, some of the other names that fall under the definition of Autism Spectrum Disorder may include classic autism, Asperser's syndrome, PDD-NOS (pervasive developmental disorder, not otherwise specified), and atypical autism. The financial burden associated with those diagnosed with Autism Spectrum Disorder can be substantial, in fact over one's lifetime it is estimated to cost $3.2 million.

An embodiment of the invention may be tailored to individuals dealing with autism issues. From the assessment stage through adulthood, autism management is a never ending battle for those afflicted and their loved ones. Behavioral management, language, life and social skills often require special schools, special day/child care and increased medical expenses. Products may include, for example, safety proofing ones home, identification cards, and tracking kits. Additionally, sensitivity to textures and fabrics, difficulty with fasteners, and fit may require specialty clothing. Learning tools such as puzzles, workbooks, flash cards, software and expensive eye hand coordination devices can help parents aid in their child's development. Recently studies suggest revising one's dietary and nutritional intake as a promising trend in managing Autism Spectrum Disorders. Cookbooks, books, workbooks, journals, chore guides, routine oriented calendars, all help keep the family and child on track and are all out-of-pocket and often not covered by medical insurance. Specialists such as nutritionists, speech pathologists (40% of Autistic children do not speak at all), developmental pediatricians, behavioral therapists, physical therapists, life coaches and support groups for children and family members alike are disorganized and often come by “word of mouth.”

Family members are often concerned about their loved ones ability to survive after they are gone, therefore legal advice and preparation may be necessary, and costly. A variety of products may be needed to augment a healthcare professional's course of treatment. The overwhelming cost to support your loved ones may be substantial.

### Illustrative Computer System

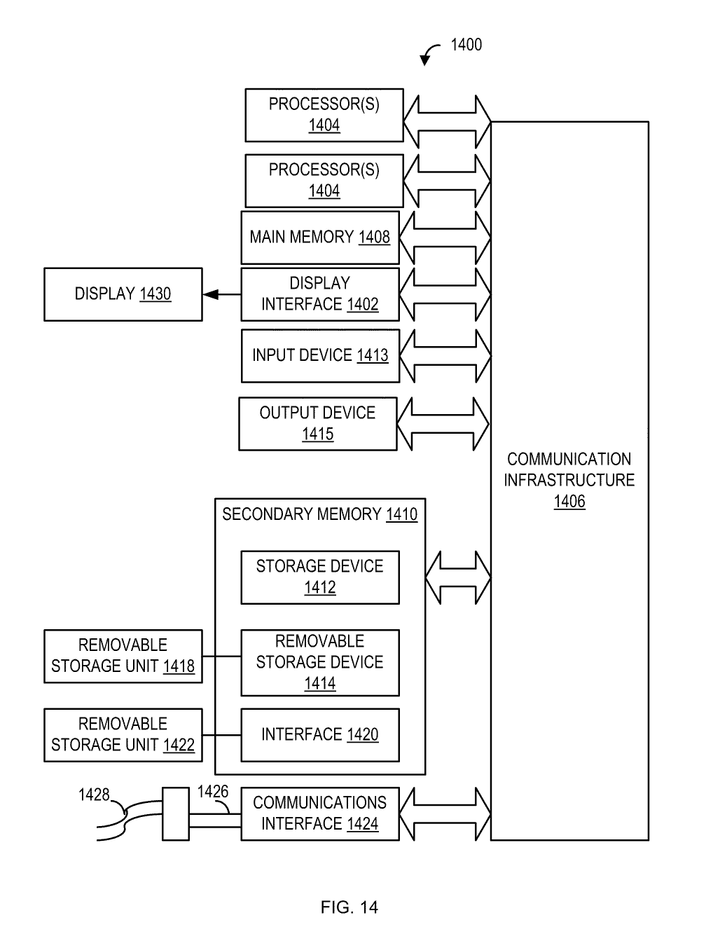

FIG. 14 depicts an illustrative computer system that may be used in implementing an illustrative embodiment of the present invention. Specifically, FIG. 14 depicts an illustrative embodiment of a computer system 1400 that may be used in computing devices such as, e.g., but not limited to, standalone or client or server devices. FIG. 14 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein.

An example of a computer system 1400 is shown in FIG. 14, depicting an illustrative embodiment of a block diagram of an illustrative computer system useful for implementing the present invention. Specifically, FIG. 14 illustrates an example computer 1400, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/etc. available from MICROSOFT® Corporation of Redmond, Wash., U.S.A. or an Apple computer executing MAC® OS from Apple® of Cupertine, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 1400 is shown in FIG. 14. Other components of the invention, such as, e.g., (but not limited to) a computing device, a communications device, a telephone, a personal digital assistant (PDA), an iPhone, a 3G wireless device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 14. In an illustrative embodiment, services may be provided on demand using, e.g., an interactive television device (iTV), a video on demand system (VOD), via a digital video recorder (DVR), and/or other on demand viewing system.

The computer system 1400 may include one or more processors, such as, e.g., but not limited to, processor(s) 1404. The processor(s) 1404 may be connected to a communication infrastructure 1406 (e.g., but not limited to, a communications bus, cross-over bar, interconnect, or network, etc.). Processor 1404 may include any type of processor, microprocessor, or processing logic that may interpret and execute instructions (e.g., for example, a field programmable gate array (FPGA)). Processor 1404 may comprise a single device (e.g., for example, a single core) and/or a group of devices (e.g., multi-core). The processor 1404 may include logic configured to execute computer-executable instructions configured to implement one or more embodiments. The instructions may reside in main memory 1408 or secondary memory 1410. Processors 1404 may also include multiple independent cores, such as a dual-core processor or a multi-core processor. Processors 1404 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 1400 may include a display interface 1402 that may forward, e.g., but not limited to, graphics, text, and other data, etc., from the communication infrastructure 1406 (or from a frame buffer, etc., not shown) for display on the display unit 1430. The display until 1430 may be, for example, a television, a computer monitor, or a mobile phone screen. The output may also be provided as sound through a speaker.

The computer system 1400 may also include, e.g., but is not limited to, a main memory 1408, random access memory (RAM), and a secondary memory 1410, etc. Main memory 1408, random access memory (RAM), and a secondary memory 1410, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 1410 may include, for example, (but is not limited to) a hard disk drive 1412 and/or a removable storage drive 1414, representing a floppy diskette drive, a magnetic tape drive, an optical disk drive, a compact disk drive CD-ROM, flash memory, etc. The removable storage drive 1414 may, e.g., but is not limited to, read from and/or write to a removable storage unit 1418 in a well known manner. Removable storage unit 1418, also called a program storage device or a computer program product, may represent, e.g., but is not limited to, a floppy disk, magnetic tape, optical disk, compact disk, etc. which may be read from and written to removable storage drive 1414. As will be appreciated, the removable storage unit 1418 may include a computer usable storage medium having stored therein computer software and/or data.

In alternative illustrative embodiments, secondary memory 1410 may include other similar devices for allowing computer programs or other instructions to be loaded into computer system 1400. Such devices may include, for example, a removable storage unit 1422 and an interface 1420. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1422 and interfaces 1420, which may allow software and data to be transferred from the removable storage unit 1422 to computer system 1400.

Computer 1400 may also include an input device 1413 may include any mechanism or combination of mechanisms that may permit information to be input into computer system 1400 from, e.g., a user. Input device 1413 may include logic configured to receive information for computer system 1400 from, e.g. a user. Examples of input device 1413 may include, e.g., but not limited to, a mouse, pen-based pointing device, or other pointing device such as a digitizer, a touch sensitive display device, and/or a keyboard or other data entry device (none of which are labeled). Other input devices 1413 may include, e.g., but not limited to, a biometric input device, a video source, an audio source, a microphone, a web cam, a video camera, and/or other camera.

Computer 1400 may also include output devices 1415 which may include any mechanism or combination of mechanisms that may output information from computer system 1400. Output device 1415 may include logic configured to output information from computer system 1400. Embodiments of output device 1415 may include, e.g., but not limited to, display 1430, and display interface 1402, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 1400 may include input/output (I/O) devices such as, e.g., (but not limited to) communications interface 1424, cable 1428 and communications path 1426, etc. These devices may include, e.g., but are not limited to, a network interface card, and/or modems.

Communications interface 1424 may allow software and data to be transferred between computer system 1400 and external devices.

In this document, the terms “computer program medium” and “computer readable medium” may be used to generally refer to media such as, e.g., but not limited to, removable storage drive 1414, a hard disk installed in hard disk drive 1412, flash memories, removable discs, non-removable discs, etc. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to computer system 1400. It should be noted that a computer-readable medium that comprises computer-executable instructions for execution in a processor may be configured to store various embodiments of the present invention. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may.

Unless specifically stated otherwise, as apparent from the following discussions, it is appreciated that throughout the specification discussions utilizing terms such as “processing,” “computing,” “calculating, ” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

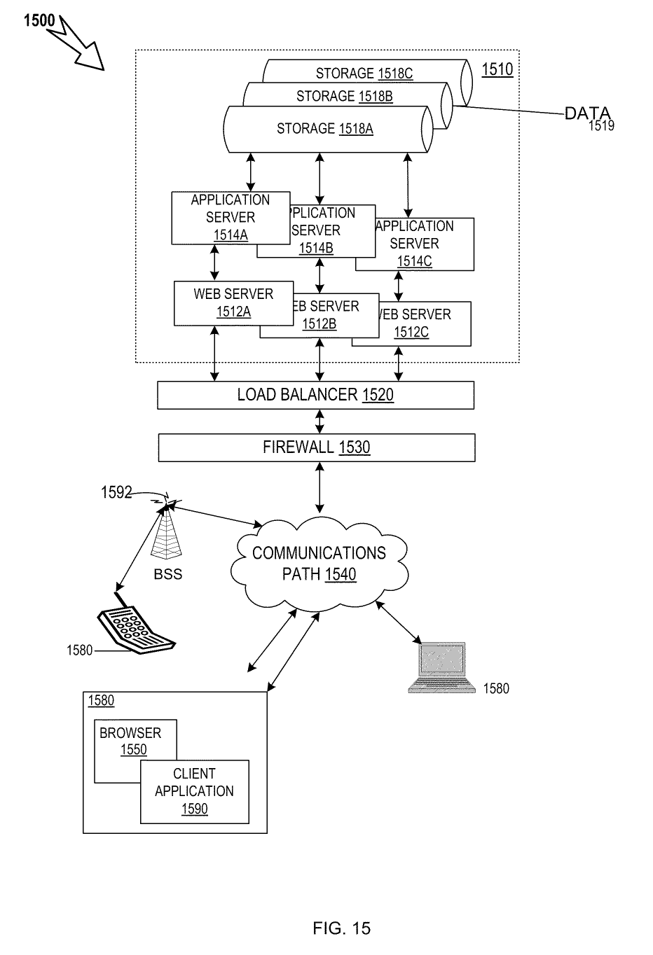

FIG. 15 depicts an example high-level view of an illustrative embodiment of a workflow storage and distribution system 1500 according to an illustrative embodiment of the present invention. The workflow communication and/or computing device 1510 may create, store, transmit, and receive electronic transmissions. The workflow communication and/or computing device 1510 may provide data storage for multiple workflows and context information. Workflow communication and/or computing device 1510 may also allow for data transactions to and from various client devices 1580. Both the workflow communication and/or computing device 1510 and the client devices 1580 may be a computing device 1400 or any other device capable of interacting with communications path 1540. The client devices 1580 may be mobile devices that may wirelessly transmit data and voice information with the base station subsystem (BSS) 1592. The BSS 1592 may be responsible for handling traffic and signaling between a mobile device 1580 and the communication path 1540.

The physical or logical storage unit 1518 may, for example, store workflow data, sample queries, text or video, photographs, audio, text, marketing information, product information, and client data. The servers 1512 and 1514 may be coupled to client devices 1400 through a communications path 1540 (e.g., but not limited to, the Internet) via a load balancer 1520 and a firewall 1530. According to another embodiment (not shown), the distribution system 1500 could be represented by any of a number of well known network architecture designs including, but not limited to, peer-to-peer, client-server, hybrid-client (e.g., thin-client), or standalone. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc. Any other hardware architecture such as, e.g., but not limited to, a services oriented architecture (SOA) could also be used.

The client devices 1580 may be equipped with a dedicated workflow application 1590 that may provide the workflow functionality described in the paragraphs above. Alternatively, client devices 1580 may contain a browser 1550 (e.g., but not limited to, Internet Explorer, Firefox, Opera, etc.), which may, in conjunction with web server 1512, provide the same functionality as the dedicated workflow application 1590.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application. It may also be part of a healthcare provider's system (e.g., a hospital, doctor's office, etc.).

FIG. 15 depicts an example high-level view of an illustrative embodiment of a workflow storage and distribution system 1500 according to an illustrative embodiment of the present invention. The workflow communication and/or computing device 1510 may create, store, transmit, and receive electronic transmissions. The workflow communication and/or computing device 1510 may provide data storage for multiple workflows and context information. Workflow communication and/or computing device 1510 may also allow for data transactions to and from various client devices 1580. The workflow communication and/or computing device 1510 and the client devices 1580 may be a computing device 1400 or any other device capable of interacting with communications path 1540. The client devices 1580 may be mobile devices that may wirelessly transmit data and voice information with a base station subsystem (BSS) 1592. The BSS 1592 may be responsible for handling traffic and signaling between a mobile device 1580 and the communication path 1540.

The physical or logical storage unit 1518 may, for example, store workflow data 1519, queries, product and services ratings, text or video, photographs, audio, text, marketing information, product information, and client data. The stored data 1519 may be stored and used for data mining purposes to calculate, for example, marketing trends over time and efficacy of products and services. The servers 1512 and 1514 may be coupled to client devices 1400 through a communications path 1540 (e.g., but not limited to, the Internet) via a load balancer 1520 and a firewall 1530.

According to another embodiment (not shown), the distribution system 1500 could be represented by any of a number of well-known network architecture designs including, but not limited to, peer-to-peer, client-server, hybrid-client (e.g., thin-client), or standalone. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc. Any other hardware architecture such as, e.g., but not limited to, a services oriented architecture (SOA) could also be used.

The client devices 1580 may be equipped with a dedicated workflow application 1590 that may provide the workflow functionality described in the paragraphs above. Alternatively, client devices 1580 may contain a browser 1550 (e.g., but not limited to, Internet Explorer, Firefox, Opera, etc.), which may, in conjunction with web server 1512, provide the same functionality as the dedicated workflow application 1590

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents.

What is claimed is:

1. A tangible non-transitory computer-readable storage media for storing computer-executable instructions executable by processing logic, the media storing one or more instructions for steps comprising:
providing a catalog in a computing environment, wherein the catalog contains a plurality of specialty items relevant to a particular disease or disorder at a given stage or treatment cycle of the disease or disorder;
providing a secure personal registry of one or more specialty items selected from the catalog by a customer;
receiving registry item recommendations for inclusion into the secure personal registry, wherein the registry item recommendations are provided by experts, customers, or third-parties;
receiving a plurality of catalog item recommendations from experts, customers, or third-parties;
updating the catalog based on the plurality of catalog item recommendations or on specialty items sales data;
receiving a financial contribution or an in-kind contribution to the secure personal registry of specialty items from a contributor;
processing a sales transaction for one or more specialty items in the secure personal registry; and
storing relational data regarding the specialty items, customers, registry item recommendations, catalog item recommendations, sales transaction, and the disease or disorder.

2. The media of claim 1, wherein the disease or disorder is at least one of: breast cancer, prostate cancer, lung cancer, prostate cancer, lupus, arthritis, heart disease, autism, multiple sclerosis, sleep disorders, or migraines.

3. The media of claim 1, wherein updating the catalog further comprises one of:
adding additional specialty items into the catalog; or
removing specialty items from the catalog.

4. The media of claim 1, further storing one or more instructions for:
transmitting information about ingredients of a specialty item to at least one of:
health care providers, customers, potential customers, experts, manufacturers, or third parties.

5. The media of claim 1, wherein the contributor is at least one of:
a friend, a family member, a coworker, an employer, a religious organization, a charitable organization, an anonymous contributor, a foundation, a product manufacturer, or a community group.

6. The media of claim 1, wherein the registry item recommendations comprise at least one of:
a quicklist or an email list.

7. The media of claim 1, further storing one or more instructions for maintaining privacy of personal customer data.

8. The storage media of claim 1, wherein storing relational data further comprises:
providing a relationship between the plurality of specialty items, ingredients of the specialty items, expert recommendations and reviews, customer recommendations and reviews, third-party recommendations and reviews, customer information, registry item recommendations, the given stage, the treatment cycle, and disease or disorders.

9. The storage media of claim 1, wherein the specialty items comprise at least one of goods or services.

10. The storage media of claim 9, wherein the goods comprise at least one item suitable for a breast cancer patient selected from:
health care products, clothing, breast forms, specially designed bras, medical support garments, skin care products, specially designed headwear and turbans, specially designed swimwear, books, bedding, real estate, wigs, prosthetics, deodorant, or toothpaste.

11. The storage media of claim 9, wherein the services comprise at least one service required for a customer having a disease or disorder selected from:
health care, pet care, doctor visits, home cleaning, medical procedures, travel, massage, wig fitting, prosthetic fitting, occupational therapy, physical therapy, health specialists, cooking, meal delivery, pet finder, babysitting, driving, carpooling, eldercare, hospice, house swaps, vacation houses, yard work, sponsorship of co-payments, or gift cards.

12. The media of claim 9, further storing one or more instructions for:
receiving selection of a service;
determining one or more forms associated with the service; and
populating one or more fields of the one or more forms with customer information.

13. The media of claim 1, wherein the financial contribution further comprises:
a financial contribution towards a full or partial purchase of one or more of the plurality of specialty items or one or more categories of specialty items by a customer.

14. The media of claim 1, further storing one or more instructions for:
notifying the customer when a contribution is made.

15. The media of claim 1, further storing one or more instructions for:
creating a quicklist based on the registry item recommendations provided by experts or third-parties.

16. The media of claim 1, wherein the given stage for a disease or disorder is at least one of:
preventative, discovery, diagnosis, treatment, therapy, latency, remission, recovery, or comfort care.

17. A computer-implemented method for servicing the needs of a plurality of customers with diseases or disorders, the method comprising:
associating, by a computer, each customer of the plurality of customers with a particular disease or disorder at a particular stage or treatment cycle;
providing a comprehensive catalog, by the computer, wherein the catalog comprises a plurality of specialty items targeted to each customer of the plurality of customers based on the particular disease or disorder at the particular stage or treatment cycle;
providing a plurality of secure registries by the computer, wherein the plurality of secure registries are associated with the plurality of customers;
receiving, by the computer, a plurality of registry recommendations of specialty items from experts or customers;
providing, by the computer, registry recommendations to customers based on the particular disease or disorder at the particular stage or treatment cycle of the disease or disorder;
receiving, by the computer, a selection by a customer of one specialty item from the registry recommendations;
inserting, by the computer, the one specialty item into an individual secure registry, wherein the individual secure registry is one of the plurality of secure registries;
transmitting to the contributor, by the computer, a link allowing viewing of the individual secure registry;
accepting, by the computer, a monetary contribution into the individual secure registry; and
transmitting, by the computer, notification of the monetary contribution.

18. The computer-implemented method of claim 17, further comprising:
collecting relational information regarding the plurality of specialty items, item ingredients, customers, diseases or disorders, stages, treatment cycles, and recommendations.

19. The computer-implemented method of claim 18, further comprising:
maintaining privacy of personal customer data.

20. The computer-implemented method of claim 17, further comprising:
transmitting item ingredient information to at least one of: a healthcare provider, a customer, a potential customer, or an expert.

21. The computer-implemented method of claim 17, wherein the particular stage of the particular disease or disorder comprises at least one of:
preventative, discovery, diagnosis, treatment, therapy, latency, remission, recovery, or comfort care.

22. The computer-implemented method of claim 17, further comprising:
receiving a plurality of catalog recommendations from experts or customers.

23. The computer-implemented method of claim 22, further comprising:
adding or removing specialty items from the catalog based on the catalog recommendations from experts or customers; and
removing specialty items from the catalog based on specialty items sales data.

24. The computer-implemented method of claim 17, further comprising:
creating a quicklist based on registry recommendations.

25. A computer-implemented system for servicing needs of a plurality of customers with a particular disease or disorder, comprising:
a storage device storing a relational database holding relational information on specialty items, item ingredients, customer data, diseases, disorders, stages of the disease or disorder, treatment cycles, expert recommendations, and customer reviews; and
a processor configured to:
process a catalog of specialty items relevant to the needs of individual customers from the plurality of customers at a given stage or treatment cycle of the disease or disorder;
process a plurality of secure personal registries of specialty items selected from the catalog by individual customers;
process recommendations from experts on specialty items for inclusion in personal registries of individual customers;
process recommendations from experts or customers on specialty items for inclusion or exclusion from the catalog;
update the specialty items in the catalog based on the recommendations from experts or customers;
process contributions from contributors of funds to personal registries, wherein the contributions may be whole or partial purchase price of an item;
collecting the relational information; and
maintaining privacy of personal customer data stored on the storage device.

26. A computer-implemented method for matching patients with contributors, the method comprising:
providing a catalog of products for a plurality of customers by the computer, wherein the plurality of customers are patients or survivors and the products are goods and services;
providing a registry for each customer in the plurality of customers by the computer, wherein the registry contains a selection of one or more products from the catalog of products;
receiving, by the computer, product recommendations from a medical doctor;
transmitting to the medical doctor, by the computer, an ingredient list for the products recommendations;
providing, by the computer, a list of recommended products based on a selection of the medical doctor;
inserting, by the computer, one or more doctor recommended products into the registry;
transmitting, by the computer, a link to a contributor, wherein the link allows the contributor to access the registry;
receiving, by the computer, a contribution from the contributor for at least one of: a purchase of one or more products in the registry or a monetary contribution; and
receiving, by the computer, one or more customer ratings for one or more products.
